(19) United States
(12) Patent Application Publication
(10) Pub. No.: US 2025/0237764 A1
(43) Pub. Date: Jul. 24, 2025

(54) DISTANCE MEASURING DEVICE AND DISTANCE MEASURING METHOD

(71) Applicant: Nuvoton Technology Corporation Japan, Kyoto (JP)

(72) Inventors: Miwa ICHIRYU, Osaka (JP); Toru YAMADA, Kyoto (JP); Yasuyuki SHIMIZU, Kyoto (JP); Masahiko NISHIMOTO, Osaka (JP)

(21) Appl. No.: 19/175,414

(22) Filed: Apr. 10, 2025

Related U.S. Application Data
(63) Continuation of application No. PCT/JP2023/037092, filed on Oct. 12, 2023.
(60) Provisional application No. 63/417,190, filed on Oct. 18, 2022.

(51) Int. Cl. G01S 17/48; G01S 7/48; G01S 7/481; G01S 7/484; G01S 7/4863; G01S 7/4865; G01S 7/4911; G01S 7/4914; G01S 7/4915; G01S 17/10; G01S 17/32

(52) U.S. Cl. CPC G01S 17/48; G01S 7/4808; G01S 7/4815; G01S 7/4816; G01S 7/484; G01S 7/4863; G01S 7/4865; G01S 7/4911; G01S 7/4914; G01S 7/4915; G01S 17/10; G01S 17/32

(57) ABSTRACT

A distance measuring device includes: a light source unit that emits irradiation light; a light receiver including a pixel that generates a pixel signal based on incident light; a drive controller that controls driving of the light source unit and the light receiver; and a signal processor that derives a distance to a target object based on the pixel signal. The drive controller drives the light source unit and the pixel through a continuous wave (CW) time-of-flight (ToF) sequence and a pulse ToF sequence that are sequences for measuring a distance using mutually different types of indirect ToF methods. The signal processor derives the distance to the target object based on a first pixel signal generated by the pixel in the CW-ToF sequence and a second pixel signal generated by the pixel in the pulse ToF sequence.

### CROSS REFERENCE TO RELATED APPLICATIONS

This is a continuation application of PCT International Patent Application No. PCT/JP2023/037092 filed on Oct. 12, 2023, designating the United States of America, which is based on and claims priority of U.S. Provisional Patent Application No. 63/417,190 filed on Oct. 18, 2022. The entire disclosures of the above-identified applications, including the specifications, drawings and claims are incorporated herein by reference in their entirety.

### FIELD

The present disclosure relates to a distance measuring device and a distance measuring method.

### BACKGROUND

Conventional distance measuring devices employing indirect time of flight (ToF) methods have been known.

As one of the indirect ToF methods, a continuous wave ToF (hereinafter also referred to as CW-ToF) method has been known. In this method, irradiation light, which is modulated light having a predetermined emission frequency, is emitted and a distance is calculated from the phase difference between the irradiation light and reflected light of the irradiation light that has reflected off a target object (see Patent Literature (PTL) 1, for example).

### CITATION LIST

### Patent Literature

PTL 1: Japanese Unexamined Patent Application Publication (Translation of PCT Application) No. 2013-538342

### SUMMARY

### Technical Problem

With the CW-ToF method, the distance measurement range is limited by the frequency of the irradiation light; the lower the frequency, the greater the distance measurement range. On the other hand, the higher the frequency of the irradiation light, the higher the distance measurement accuracy.

With the CW-ToF method, when the distance is calculated based on reflected light that has reflected off the target object located beyond the distance measurement range, the calculated distance is wrapped around because the phase difference of from 0 degrees to 360 degrees is repeated. As a result, a false distance shorter than the actual distance is calculated, and distance measurement cannot be performed accurately.

PTL 1 discloses a technique of expanding the distance measurement range in the CW-ToF method by emitting irradiation light at a plurality of frequencies and calculating the distance based on signals obtained based on the irradiation light at the respective frequencies.

The technique according to PTL 1 extends the distance measurement range based on the relationship between the plurality of frequencies. However, even with the technique described in PTL 1, in the case of calculating a distance based on reflected light that has reflected off the target object located beyond the extended distance measurement range, a false distance shorter than the actual distance is calculated as in the case of using irradiation light of a single frequency.

In view of the above, the present disclosure provides a distance measuring device and a distance measuring method that can achieve both expansion of the distance measurement range and improvement in the distance measurement accuracy.

### Solution to Problem

A distance measuring device according to an aspect of the present disclosure is a distance measuring device that measures a distance to a target object using an indirect time-of-flight (ToF) method, the distance measuring device including: a light source unit that emits irradiation light; a light receiver including a pixel that generates a pixel signal based on incident light; a drive controller that controls driving of the light source unit and the light receiver; and a signal processor that derives the distance to the target object based on the pixel signal, wherein the drive controller: drives the light source unit and the pixel through a continuous wave ToF sequence and a pulse ToF sequence that are sequences for measuring a distance using mutually different types of indirect ToF methods; and switches between the continuous wave ToF sequence and the pulse ToF sequence between frames, a distance measurement range in the pulse ToF sequence is longer than a distance measurement range in the continuous wave ToF sequence, and the signal processor derives the distance to the target object based on a first pixel signal generated by the pixel in the continuous wave ToF sequence and a second pixel signal generated by the pixel in the pulse ToF sequence.

A distance measuring method according to an aspect of the present disclosure is a distance measuring method performed by a distance measuring device for measuring a distance to a target object using an indirect time-of-flight (ToF) method, the distance measuring device including: a light source unit that emits irradiation light; and a light receiver including a pixel that generates a pixel signal based on incident light, the distance measuring method including: driving the light source unit and the pixel through a continuous wave ToF sequence and a pulse ToF sequence that are sequences for measuring a distance using mutually different types of indirect ToF methods; and deriving the distance to the target object based on a first pixel signal generated by the pixel in the continuous wave ToF sequence and a second pixel signal generated by the pixel in the pulse ToF sequence, wherein the driving includes switching between the continuous wave ToF sequence and the pulse ToF sequence between frames, and a distance measurement range in the pulse ToF sequence is longer than a distance measurement range in the continuous wave ToF sequence.

### Advantageous Effects

The present disclosure can achieve both expansion of the distance measurement range and improvement in the distance measurement accuracy.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a functional block diagram illustrating an example of a configuration of a distance measuring device according to an embodiment.

FIG. 2 is a schematic diagram of a pixel array included in a light receiver according to an embodiment.

FIG. 3 is a plan view illustrating an example of a configuration of a pixel according to an embodiment.

FIG. 4 is a diagram illustrating an example of a drive sequence of a distance measuring device according to an embodiment.

FIG. 5 is a timing diagram illustrating an example of a first CW emission and exposure period and a second CW emission and exposure period in a CW-ToF sequence according to an embodiment.

FIG. 6 is a timing diagram illustrating an example of a first pulse emission and exposure period and a second pulse emission and exposure period in a pulse ToF sequence according to an embodiment.

FIG. 7 is a diagram for describing estimated distances calculated using a CW-ToF method and a pulse ToF method.

FIG. 8 is a diagram for describing a multipath.

FIG. 9 is a first diagram for describing the impact that a multipath has on estimated distances.

FIG. 10 is a second diagram for describing the impact that a multipath has on estimated distances.

FIG. 11 is a third diagram for describing the impact that a multipath has on estimated distances.

FIG. 12 is a diagram illustrating a first different example of a drive sequence of a distance measuring device according to an embodiment.

FIG. 13 is a diagram illustrating a second different example of a drive sequence of a distance measuring device according to an embodiment.

FIG. 14 is a timing diagram illustrating an example of a first CW emission and exposure period and a second CW emission and exposure period in another CW-ToF sequence according to an embodiment.

FIG. 15 is a plan view illustrating an example of a configuration of a pixel according to Variation 1 of an embodiment.

FIG. 16 is a diagram illustrating an example of a drive sequence of a distance measuring device according to Variation 1 of an embodiment.

FIG. 17 is a timing diagram illustrating an example of a first CW emission and exposure period in a CW-ToF sequence according to Variation 1 of an embodiment.

FIG. 18 is a timing diagram illustrating an example of a first CW emission and exposure period in another CW-ToF sequence according to Variation 1 of an embodiment.

FIG. 19 is a timing diagram illustrating an example of a first pulse emission and exposure period in a pulse ToF sequence according to Variation 1 of an embodiment.

FIG. 20 is a plan view illustrating an example of a configuration of a pixel according to Variation 2 of an embodiment.

FIG. 21 is a diagram illustrating an example of a drive sequence of a distance measuring device according to Variation 2 of an embodiment.

FIG. 22 is a timing diagram illustrating an example of a first CW emission and exposure period in a CW-ToF sequence according to Variation 2 of an embodiment.

FIG. 23 is a timing diagram illustrating an example of a first pulse emission and exposure period in a pulse ToF sequence according to Variation 2 of an embodiment.

### DESCRIPTION OF EMBODIMENT

Hereinafter, an exemplary embodiment of the present disclosure will be described in detail with reference to the drawings.

Note that the exemplary embodiment described below shows a comprehensive or specific example. The numerical values, shapes, constituent elements, the arrangement and connection of the constituent elements, steps, and the processing order of the steps etc. shown in the following embodiment are mere examples, and therefore do not intend to limit the present disclosure. Among the constituent elements in the following embodiment, those not recited in any of the independent claims will be described as optional constituent elements. The drawings are represented schematically and are not necessarily precise illustrations. In the drawings, constituent elements that are substantially the same are given the same reference signs, and redundant descriptions will be omitted or simplified.

In the present specification, terms indicating a relationship between elements, such as “perpendicular”, “parallel” and “the same”, terms indicating the shapes of elements, such as “circular” and “rectangular”, and numerical value ranges do not express their strict meanings only, but also include substantially equivalent ranges, e.g., differences of several percent.

In the present specification, ordinal numerals such as “first” and “second” do not mean the number or order of constituent elements etc. unless otherwise stated in particular. The ordinal numerals are used to avoid confusion of and distinguish between constituent elements of the same type.

### Embodiment

### [Configuration]

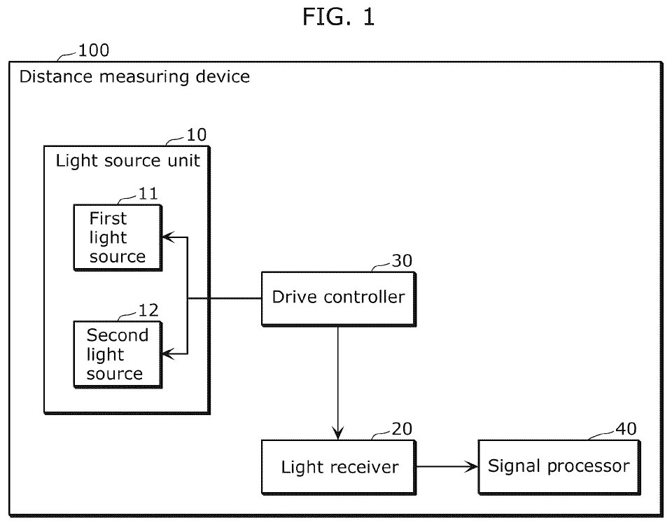

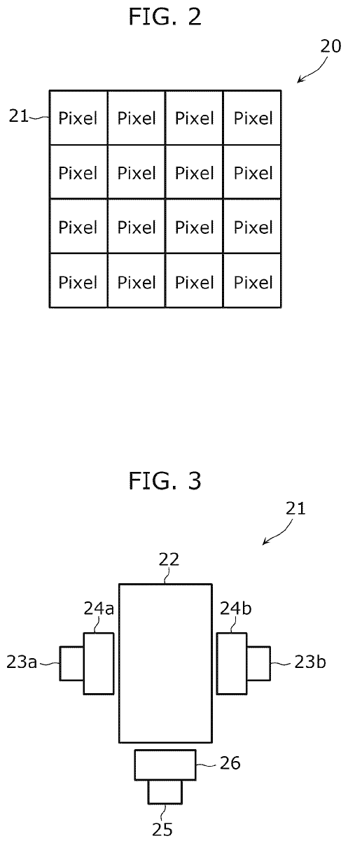

First, a configuration of a distance measuring device according to the present embodiment will be described. FIG. 1 is a functional block diagram illustrating an example of a configuration of distance measuring device 100 according to the embodiment. FIG. 2 is a schematic diagram of a pixel array included in light receiver 20 according to the embodiment.

FIG. 3 is a plan view illustrating an example of a configuration of pixel 21 according to the embodiment.

Distance measuring device 100 is a distance measuring device that measures a distance to a target object using an indirect ToF method. Distance measuring device 100, for example, generates a distance image indicating a distance to a subject that is an example of a target object.

Distance measuring device 100 includes light source unit 10, light receiver 20, drive controller 30, and signal processor 40.

Light source unit 10 is, for example, a light irradiator that emits irradiation light to a target object according to an emission control signal that is input to light source unit 10. For example, light source unit 10 emits a plurality of pulsed light rays that repeat at a predetermined duty cycle as irradiation light according to the timing indicated by an emission control pulse included in the emission control signal input to light source unit 10.

In the example illustrated in FIG. 1, light source unit 10 includes two light sources, namely first light source 11 and second light source 12. First light source 11 emits irradiation light in a CW-ToF sequence which will be described later. Second light source 12 emits irradiation light in a pulse ToF sequence which will be described later. First light source 11 and second light source 12 each include, for example: a light-emitting element such as a light-emitting diode or a laser element that emits infrared light; and an optical system on which the light from the light-emitting element is incident and which controls distribution of the light from the light-emitting element. Note that light source unit 10 is not limited to the example of including two light sources, and may include one light source that emits irradiation light in both the CW-ToF sequence and the pulse ToF sequence.

Light receiver 20 includes, for example, an imaging element such as a charge coupled device (CCD) sensor or a complementary metal oxide semiconductor (CMOS) sensor. As illustrated in FIG. 2, light receiver 20 includes a pixel array in which a plurality of pixels 21 are two-dimensionally arranged. For the sake of explanation, FIG. 2 illustrates 4 pixels in each row and 4 pixels in each column for a total of 16 pixels; however, the total number of pixels 21 included in light receiver 20 is not particularly limited. The plurality of pixels 21 are mutually the same in configuration, for example.

Pixels 21 generate pixel signals based on incident light. In detail, pixels 21 convert incident light into signal charge and generate pixel signals based on the signal charge obtained by the conversion.

As illustrated in FIG. 3, each pixel 21 includes photoelectric converter 22, a plurality of charge accumulators 23a and 23b, a plurality of charge transferers 24a and 24b, charge drainer 25, and drain controller 26. Photoelectric converter 22, the plurality of charge accumulators 23a and 23b, the plurality of charge transferers 24a and 24b, charge drainer 25, and drain controller 26 are provided to a semiconductor substrate, for example.

Photoelectric converter 22 generates signal charge by converting incident light that is incident on pixel 21 into signal charge. The incident light incident on pixel 21 includes, for example, reflected light of the irradiation light that has been emitted from light source unit 10 and has reflected off the target object. Photoelectric converter 22 includes, for example, a photoelectric conversion element such as a photodiode.

Each of the plurality of charge accumulators 23a and 23b accumulates the signal charge obtained by the conversion performed by photoelectric converter 22. The plurality of charge transferers 24a and 24b are provided corresponding one-on-one to the plurality of charge accumulators 23a and 23b. Pixel 21 includes two charge accumulators and two charge transferers. The plurality of charge transferers 24a and 24b are electrically connected to photoelectric converter 22 and transfer, from photoelectric converter 22 to the plurality of charge accumulators 23a and 23b, the signal charge obtained by the conversion performed by photoelectric converter 22. Specifically, charge transferer 24a transfers the signal charge to charge accumulator 23a, and charge transferer 24b transfers the signal charge to charge accumulator 23b. The plurality of charge transferers 24a and 24b are, for example, field-effect transistors (FETs) provided to the semiconductor substrate. The plurality of charge accumulators 23a and 23b are each, for example, an impurity region that functions as the source or drain of the corresponding FET.

The signal charge accumulated in the plurality of charge accumulators 23a and 23b is read out as a pixel signal by a signal detection circuit that is not illustrated. The signal detection circuit, for example, reads out pixel signals corresponding to the electric potentials of the plurality of charge accumulators 23a and 23b. The pixel signals read out from respective pixels 21 include signals indicating signal values that are based on the amounts of signal charge accumulated in the plurality of charge accumulators 23a and 23b.

Charge drainer 25 drains the signal charge obtained by the conversion performed by photoelectric converter 22. For example, a predetermined reset voltage is applied to charge drainer 25. The reset voltage may be a ground voltage. Drain controller 26 is electrically connected to photoelectric converter 22 and controls the draining, performed by charge drainer 25, of the signal charge obtained by the conversion performed by photoelectric converter 22. By causing charge drainer 25 to drain the signal charge, drain controller 26 resets the charge generated by photoelectric converter 22. Drain controller 26 is, for example, an FET provided to the semiconductor substrate. Charge drainer 25 is, for example, an impurity region that functions as the source or drain of the FET.

Referring to FIG. 1 again, drive controller 30 controls driving of light source unit 10 and light receiver 20. For example, drive controller 30 outputs, as an emission control signal for controlling the driving of light source unit 10, an emission control pulse that instructs light source unit 10 to emit irradiation light at a predetermined pulse width. The emission control pulse includes a plurality of pulses for causing light source unit 10 to repeatedly emit pulsed light. As the irradiation light, light source unit 10 emits a plurality of pulsed light rays at a timing in accordance with the emission control pulse.

Also, for example, drive controller 30 outputs, as a control signal for controlling the driving of light receiver 20, an exposure control pulse that instructs each pixel 21 of light receiver 20 to be exposed to light. Each pixel 21 is exposed at a timing in accordance with the exposure control pulse and accumulates signal charge. Note that in the present specification, the period of light exposure refers to a period in which signal charge to be used for readout of a pixel signal is accumulated. Thus, even if pixel 21 receives light and signal charge is thereby generated, it is not considered as light exposure if the signal charge is, for example, drained and thus not used for readout of a pixel signal. For example, light exposure refers to a state in which charge transferer 24a or 24b is in the ON state and signal charge is transferred from photoelectric converter 22 to charge accumulator 23a or 23b.

Drive controller 30 drives light source unit 10 and each pixel 21 through the CW-ToF sequence and the pulse ToF sequence that are sequences for measuring a distance using mutually different distance measurement ranges by using mutually different types of indirect ToF methods. The CW-ToF sequence is a sequence for measuring a distance using the CW-ToF method, and the pulse ToF sequence is a sequence for measuring a distance using the pulse ToF method. The CW-ToF method is an indirect ToF method in which light source unit 10 emits, as the irradiation light, continuous waves whose intensity is modulated at a predetermined cycle, and the distance is measured based on the phase difference between the irradiation light emitted by light source unit 10 and reflected light of the irradiation light reflecting off the target object and received by light receiver 20. The pulse ToF method is an indirect ToF method in which light source unit 10 emits, as the irradiation light, pulsed light having a predetermined pulse width, and the distance is measured based on the time difference between the time at which light source unit 10 emits the irradiation light and time at which light receiver 20 receives reflected light of the irradiation light that has reflected off the target object. The distance measurement range in the pulsed ToF sequence is longer than the distance measurement range in the CW-ToF sequence. The details of the CW-ToF sequence and the pulse ToF sequence will be described later.

Signal processor 40 performs signal processing related to the pixel signal that is output from light receiver 20. For each pixel 21, signal processor 40 derives the distance to the target object based on the pixel signal generated by pixel 21. Specifically, for each pixel 21, signal processor 40 derives the distance to the target object based on a first pixel signal generated by pixel 21 in the CW-ToF sequence and a second pixel signal generated by pixel 21 in the pulse ToF sequence. The details of the distance derivation performed by signal processor 40 will be described later.

Note that drive controller 30 and signal processor 40 are processing circuits implemented by, for example, memory that stores a program and a processor that executes the program. Note that although drive controller 30 and signal processor 40 are separately illustrated in the block diagram, drive controller 30 and signal processor 40 may be entirely or partly configured using the same memory and the same processor. Also, drive controller 30 and signal processor 40 may be dedicated logic circuits that perform predetermined processing.

### [Drive Sequence]

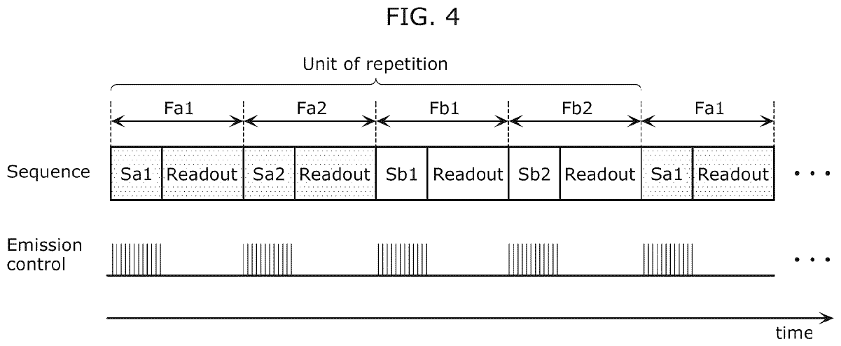

Next, a drive sequence of distance measuring device 100 according to the present embodiment will be described. FIG. 4 is a diagram illustrating an example of the drive sequence of distance measuring device 100 according to the embodiment.

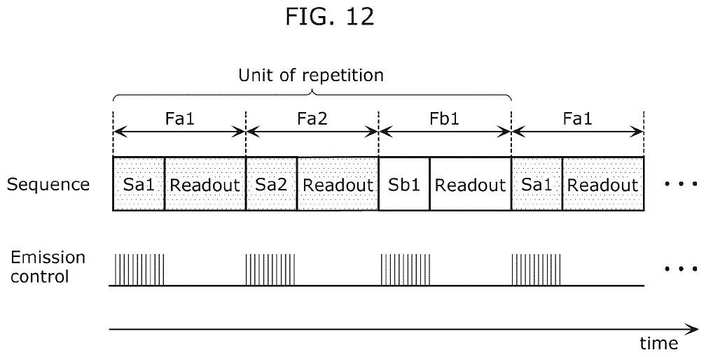

“Sequence” in FIG. 4 shows a drive sequence for driving, by drive controller 30, light source unit 10 and light receiver 20 (specifically, each pixel 21). In FIG. 4, each dotted rectangular sequence is a CW-ToF sequence for measuring a distance using the CW-ToF method, and each undotted rectangular sequence is a pulse ToF sequence for measuring a distance using the pulse ToF method. “Emission control” in FIG. 4 schematically shows periods for which drive controller 30 causes light source unit 10 to emit irradiation light. FIGS. 12, 13, 16, and 21, which will be described later, also show the same items as FIG. 4.

As illustrated in FIG. 4, drive controller 30 drives light source unit 10 and each pixel 21 through the CW-ToF sequence and the pulse ToF sequence that are time-divided. Drive controller 30 switches between the CW-ToF sequence and the pulse ToF sequence between frames. The CW-ToF sequence and the pulse ToF sequence each include one or more frames (a plurality of frames in FIG. 4). Each frame includes: an emission and exposure period during which light source unit 10 emits irradiation light and each pixel 21 is exposed; and a readout period during which a pixel signal based on signal charge generated in the emission and exposure period is read out. During the readout period of the CW-ToF sequence, the first pixel signal generated by each pixel 21 is read out. During the readout period of the pulse ToF sequence, the second pixel signal generated by each pixel 21 is read out. In the readout period, each pixel 21 is reset after the pixel signal is read out. Note that when the CW-ToF sequence and the pulse ToF sequence each include a plurality of frames, the plurality of frames may be, but need not be, consecutive in each of the CW-ToF sequence and the pulse ToF sequence. For example, a plurality of consecutive frames of one of the CW-ToF sequence or the pulse ToF sequence may be followed by a plurality of consecutive frames of the other of the CW-ToF sequence or the pulse ToF sequence. Also, for example, a given frame included in one of the CW-ToF sequence or the pulse ToF sequence may be followed by a given frame included in the other of the CW-ToF sequence or the pulse ToF sequence. That is to say, the switching of the CW-ToF sequence and the pulse ToF sequence between frames need not be performed on a frame-by-frame basis, but may be performed on a frame-by-frame basis.

In the example illustrated in FIG. 4, the CW-ToF sequence: includes first CW-ToF frame Fa1 and second CW-ToF frame Fa2 that are mutually different in timing at which each pixel 21 is exposed with respect to the timing at which light source unit 10 emits the irradiation light (specifically, a plurality of pulsed light rays which will be described later); and is made up of these two types of frames. First CW-ToF frame Fa1 includes first CW emission and exposure period Sa1 and a readout period that follows first CW emission and exposure period Sa1. Second CW-ToF frame Fa2 includes second CW emission and exposure period Sa2 and a readout period that follows second CW emission and exposure period Sa2.

Also, in the example illustrated in FIG. 4, the pulse ToF sequence: includes first pulse ToF frame Fb1 and second pulse ToF frame Fb2 that are mutually different in timing at which each pixel 21 is exposed with respect to the timing at which light source unit 10 emits the irradiation light (specifically, a plurality of pulsed light rays which will be described later); and is made up of these two types of frames. First pulse ToF frame Fb1 includes first pulse emission and exposure period Sb1 and a readout period that follows first pulse emission and exposure period Sb1. Second pulse ToF frame Fb2 includes second pulse emission and exposure period Sb2 and a readout period that follows second pulse emission and exposure period Sb2.

Drive controller 30 repeats, for a predetermined number of times, a set including first CW-ToF frame Fa1, second CW-ToF frame Fa2, first pulse ToF frame Fb1, and second pulse ToF frame Fb2. In each set, the total number of frames of each type is one. This set of frames is the unit of repetition. In the example illustrated in FIG. 4, first CW-ToF frame Fa1, second CW-ToF frame Fa2, first pulse ToF frame Fb1, and second pulse ToF frame Fb2 are repeated in the stated order; however, the order of frames in the unit of repetition is not particularly limited. In the example illustrated in FIG. 4, since the CW-ToF sequence and the pulse ToF sequence are each divided into two types of frames, the total number of charge accumulators that accumulate signal charge resulting from different exposure timings is reduced, thereby facilitating allocation of the signal charge to the charge accumulators.

In the example illustrated in FIG. 4, drive controller 30 causes light source unit 10 to emit the irradiation light during each emission and exposure period; however, drive controller 30 may cause light source unit 10 to emit the irradiation light during the readout period, too.

Next, the details of first CW emission and exposure period Sa1, second CW emission and exposure period Sa2, first pulse emission and exposure period Sb1, and second pulse emission and exposure period Sb2 will be described.

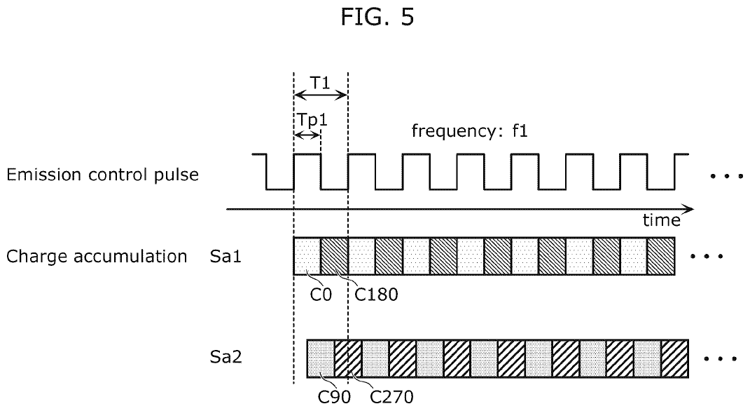

First, first CW emission and exposure period Sa1 and second CW emission and exposure period Sa2 included in the CW-ToF sequence will be described. FIG. 5 is a timing diagram illustrating an example of first CW emission and exposure period Sa1 and second CW emission and exposure period Sa2.

“Emission control pulse” in FIG. 5 shows an example of a first emission control pulse output by drive controller 30 to light source unit 10 during first CW emission and exposure period Sa1 and second CW emission and exposure period Sa2 (that is, the waveform of the irradiation light emitted by light source unit 10). The first emission control pulse output during first CW emission and exposure period Sa1 and the first emission control pulse output during second CW emission and exposure period Sa2 have the same waveform.

During first CW emission and exposure period Sa1 and second CW emission and exposure period Sa2, drive controller 30 outputs the first emission control pulse having a first duty cycle to light source unit 10 to cause light source unit 10 to emit pulsed light as the irradiation light. In the example illustrated in FIG. 5, the frequency of the first emission control pulse is f1. The pulse width of the first emission control pulse is Tp1, and the cycle of the first emission control pulse is T1. Thus, the first duty cycle of the first emission control pulse is Tp1/T1. In the example illustrated in FIG. 5, the first duty cycle is 50%; however, the distance measurement using the CW-ToF method is possible so long as the first duty cycle is at least 25% and at most 75%.

“Charge accumulation” in FIG. 5 shows exposure periods C0, C90, C180, and C270 during which drive controller 30 causes each pixel 21 to be exposed and accumulate signal charge. Specifically, drive controller 30 outputs the exposure control pulse to each pixel 21 during exposure periods C0, C90, C180, and C270 to turn on charge transferer 24a or 24b and cause charge transferer 24a or 24b to transfer signal charge from photoelectric converter 22 to charge accumulator 23a or 23b. Exposure periods C0, C90, C180, and C270 are set to periods associated with the first emission control pulse.

First CW emission and exposure period Sa1 includes exposure period C0 and exposure period C180, and exposure period C0 and exposure period C180 are alternately repeated in a continuous manner until the readout period starts. In FIG. 5, less densely dotted rectangles each represent exposure period C0 and densely shaded rectangles each represent exposure period C180. Exposure period C0 starts at a timing when the phase difference from the first emission control pulse is 0 degrees, and exposure period C180 starts at a timing when the phase difference from the first emission control pulse is 180 degrees. The total length of exposure period C0 and exposure period C180 is the same as cycle T1 of the first emission control pulse.

The charge accumulator that accumulates signal charge during exposure period C0 and the charge accumulator that accumulates signal charge during exposure period C180 are mutually different. For example, during exposure period C0, charge transferer 24b and drain controller 26 are turned off, whereas charge transferer 24a is turned on and signal charge is accumulated in charge accumulator 23a. During exposure period C180, charge transferer 24a and drain controller 26 are turned off, whereas charge transferer 24b is turned on and signal charge is accumulated in charge accumulator 23b.

During the readout period following first CW emission and exposure period Sa1, a signal based on the signal charge accumulated during exposure period C0 and a signal based on the signal charge accumulated during exposure period C180 are each read out as the first pixel signal. Hereinafter, C0 denotes the signal value of the signal corresponding to exposure period C0, and C180 denotes the signal value of the signal corresponding to exposure period C180.

Second CW emission and exposure period Sa2 includes exposure period C90 and exposure period C270, and exposure period C90 and exposure period C270 are alternately repeated in a continuous manner until the readout period starts. In FIG. 5, densely dotted rectangles each represent exposure period C90 and less densely shaded rectangles each represent exposure period C270. Exposure period C90 starts at a timing when the phase difference from the first emission control pulse is 90 degrees, and exposure period C270 starts at a timing when the phase difference from the first emission control pulse is 270 degrees. The total length of exposure period C90 and exposure period C270 is the same as cycle T1 of the first emission control pulse.

The charge accumulator that accumulates signal charge during exposure period C90 and the charge accumulator that accumulates signal charge during exposure period C270 are mutually different. For example, during exposure period C90, charge transferer 24b and drain controller 26 are turned off, whereas charge transferer 24a is turned on and signal charge is accumulated in charge accumulator 23a. During exposure period C270, charge transferer 24a and drain controller 26 are turned off, whereas charge transferer 24b is turned on and signal charge is accumulated in charge accumulator 23b.

During the readout period following second CW emission and exposure period Sa2, a signal based on the signal charge accumulated during exposure period C90 and a signal based on the signal charge accumulated during exposure period C270 are each read out as the first pixel signal. Hereinafter, C90 denotes the signal value of the signal corresponding to exposure period C90, and C270 denotes the signal value of the signal corresponding to exposure period C270.

Exposure period C0, exposure period C180, exposure period C90, and exposure period C270 are equal in length, that is, the length of each period is the cycle of the first emission control pulse divided by 2, namely T1/2. During each of first CW emission and exposure period Sa1 and second CW emission and exposure period Sa2, drive controller 30 causes each pixel 21 to be continuously exposed from the start of exposure of each pixel 21 until the start of readout of the first pixel signal. Note that an interval may be provided between the end of exposure of each pixel 21 and the start of readout of the first pixel signal. Causing each pixel 21 to be continuously exposed means that the exposure is not interrupted to drain the signal charge generated by photoelectric converter 22 during the period from the start of the exposure of each pixel 21 until the start of the readout of the first pixel signal. Thus, neither first CW emission and exposure period Sa1 nor second CW emission and exposure period Sa2 includes a charge drain period which will be described later.

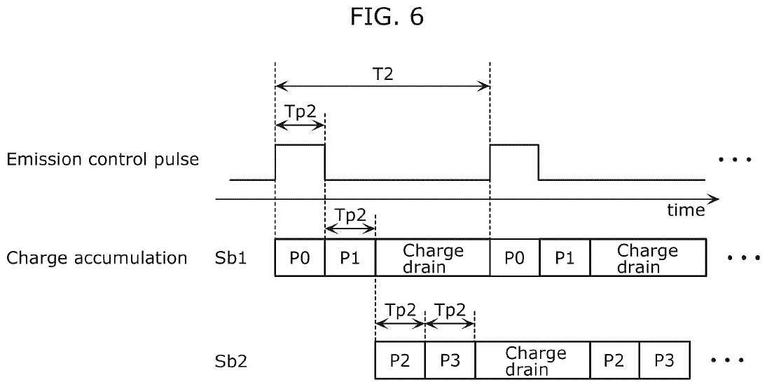

Next, first pulse emission and exposure period Sb1 and second pulse emission and exposure period Sb2 included in the pulse ToF sequence will be described. FIG. 6 is a timing diagram illustrating an example of first pulse emission and exposure period Sb1 and second pulse emission and exposure period Sb2.

“Emission control pulse” in FIG. 6 shows an example of a second emission control pulse output by drive controller 30 to light source unit 10 during first pulse emission and exposure period Sb1 and second pulse emission and exposure period Sb2 (that is, the waveform of the irradiation light emitted by light source unit 10). The second emission control pulse output during first pulse emission and exposure period Sb1 and the second emission control pulse output during second pulse emission and exposure period Sb2 have the same waveform.

During first pulse emission and exposure period Sb1 and second pulse emission and exposure period Sb2, drive controller 30 outputs the second emission control pulse having a second duty cycle to light source unit 10 to cause light source unit 10 to emit pulsed light as the irradiation light. In the example illustrated in FIG. 6, the pulse width of the second emission control pulse is Tp2, and the cycle of the second emission control pulse is T2. Thus, the second duty cycle of the second emission control pulse is Tp2/T2. The second duty cycle is less than the first duty cycle, for example. For example, the second duty cycle is less than 50%, and may be less than 25%. Pulse width Tp2 of the second emission control pulse is greater than or equal to pulse width Tp1 of the first emission control pulse, for example. Pulse width Tp2 of the second emission control pulse may be greater than pulse width Tp1 of the first emission control pulse. This allows for a wider distance measurement range and enables light source unit 10 to emit stable pulsed light in the pulse ToF sequence.

“Charge accumulation” in FIG. 6 shows: exposure periods P0, P1, P2, and P3 during which drive controller 30 causes each pixel 21 to be exposed and accumulate signal charge; and charge drain periods during which drive controller 30 causes the signal charge generated by photoelectric converter 22 of each pixel 21 to be drained. Specifically, drive controller 30 outputs the exposure control pulse to each pixel 21 during the exposure periods to turn on charge transferer 24a or 24b and cause charge transferer 24a or 24b to transfer signal charge from photoelectric converter 22 to charge accumulator 23a or 23b. Exposure periods P0, P1, P2, and P3 are set to periods associated with the second emission control pulse. Drive controller 30 outputs a charge drain pulse to each pixel 21 during the charge drain periods to turn on drain controller 26 and cause charge drainer 25 to drain signal charge generated by photoelectric converter 22. In can be said that the charge drain periods are non-exposure periods in which each pixel 21 is not exposed.

First pulse emission and exposure period Sb1 includes exposure period P0, exposure period P1, and a charge drain period. Exposure period P0, exposure period P1, and the charge drain period are repeated in the stated order until the readout period starts. Exposure period P0 starts at the same time as the start of each pulse of the second emission control pulse. Exposure period P1 starts at a timing delayed from the start of each pulse of the second emission control pulse by 1×Tp2, that is, at the end timing of exposure period P0. The charge drain period starts at the end timing of exposure period P1. The total length of exposure period P0, exposure period P1, and the charge drain period is the same as cycle T2 of the second emission control pulse.

The charge accumulator that accumulates signal charge during exposure period P0 and the charge accumulator that accumulates signal charge during exposure period P1 are mutually different. For example, during exposure period P0, charge transferer 24b and drain controller 26 are turned off, whereas charge transferer 24a is turned on and signal charge is accumulated in charge accumulator 23a. During exposure period P1, charge transferer 24a and drain controller 26 are turned off, whereas charge transferer 24b is turned on and signal charge is accumulated in charge accumulator 23b.

During the charge drain period following exposure period P1, charge drainer 25 drains the signal charge generated by photoelectric converter 22, and no signal charge is accumulated in charge accumulator 23a or 23b. During the charge drain period, charge transferers 24a and 24b are turned off and the signal charge accumulated in charge accumulators 23a and 23b are held by charge accumulators 23a and 23b. Since the charge drain period is present between the end of given exposure periods P0 and P1 and the start of next exposure periods P0 and P1, the wrap-around phenomenon less likely occurs even when the distance to the target object is long. Note that in the charge drain period, drain controller 26 need not be turned on from the start of the charge drain period so long as drain controller 26 is turned on during a predetermined period before the end of the charge drain period.

During the readout period following first pulse emission and exposure period Sb1, a signal based on the signal charge accumulated during exposure period P0 and a signal based on the signal charge accumulated during exposure period P1 are each read out as the second pixel signal. Hereinafter, P0 denotes the signal value of the signal corresponding to exposure period P0, and P1 denotes the signal value of the signal corresponding to exposure period P1.

Second pulse emission and exposure period Sb2 includes exposure period P2, exposure period P3, and a charge drain period. Exposure period P2, exposure period P3, and the charge drain period are repeated in the stated order until the readout period starts. Exposure period P2 starts at a timing delayed from the start of each pulse of the second emission control pulse by 2×Tp2. Exposure period P3 starts at a timing delayed from the start of each pulse of the second emission control pulse by 3×Tp2, that is, at the end timing of exposure period P2. The charge drain period starts at the end timing of exposure period P3. The total length of exposure period P2, exposure period P3, and the charge drain period is the same as cycle T2 of the second emission control pulse.

The charge accumulator that accumulates signal charge during exposure period P2 and the charge accumulator that accumulates signal charge during exposure period P3 are mutually different. For example, during exposure period P2, charge transferer 24b and drain controller 26 are turned off, whereas charge transferer 24a is turned on and signal charge is accumulated in charge accumulator 23a. During exposure period P3, charge transferer 24a and drain controller 26 are turned off, whereas charge transferer 24b is turned on and signal charge is accumulated in charge accumulator 23b.

During the charge drain period following exposure period P3, the same operation as in the above-described charge drain period following exposure period P1 is performed.

During the readout period following second pulse emission and exposure period Sb2, a signal based on the signal charge accumulated during exposure period P2 and a signal based on the signal charge accumulated during exposure period P3 are each read out as the second pixel signal. Hereinafter, P2 denotes the signal value of the signal corresponding to exposure period P2, and P3 denotes the signal value of the signal corresponding to exposure period P3.

Exposure period P0, exposure period P1, exposure period P2, and exposure period P3 are equal in length, that is, the length of each period is the same as pulse width Tp2 of the second emission control pulse. Exposure period P0 starts at a timing that is based on the start of each pulse of the second emission control pulse, and exposure periods P1, P2, and P3 start in the stated order at a timing delayed from the start of exposure period P0 by 1×Tp2, 2×Tp2, and 3×Tp2, respectively. Note that exposure period P0 may start at a timing delayed from the start of each pulse of the second emission control pulse by a predetermined offset.

During each of first pulse emission and exposure period Sb1 and second pulse emission and exposure period Sb2, drive controller 30 causes each pixel 21 to be intermittently exposed from the start of exposure of each pixel 21 until the start of the readout of the second pixel signal. That is to say, the charge drain period, which is a non-exposure period, is present between exposure periods. Since such a charge drain period is present, signal charge is drained and not read out as a pixel signal even if pixels 21 receive reflected light in the charge drain period, thus making it possible to inhibit generation of a pixel signal that causes distance wrap-around.

### [Derivation of Distance to Target Object]

Next, the following describes a method by which signal processor 40 derives the distance to the target object based on the pixel signals generated through the drive sequence described above.

In deriving the distance to the target object, signal processor 40 first calculates, based on the first pixel signal, a first estimated distance using distance computation according to the CW-ToF method, and calculates, based on the second pixel signal, a second estimated distance using distance computation according to the pulse ToF method. Signal processor 40 derives the distance to the target object based on the first estimated distance and the second estimated distance. The first pixel signal and the second pixel signal are output from each pixel 21 through the drive sequence described above.

First, the calculation of the first estimated distance according to the CW-ToF method will be described. Signal processor 40, for example, calculates the first estimated distance based on the first pixel signal output from each pixel 21 in the CW-ToF sequence that includes first CW emission and exposure period Sa1 and second CW emission and exposure period Sa2 described above. The first estimated distance, which is denoted by d1, is calculated using Equation (1) below.

$$\begin{matrix}[ Math . 1 ] & \\ d 1 = \frac{c}{4 π f 1} arctan \frac{C 90 - C 270}{C 0 - C 180} & ( 1 )\end{matrix}$$

Here, c denotes the speed of light. Equation (1) shown above is an equation for calculating a distance using the phenomenon that the phase of reflected light of irradiation light that has reflected off the target object is shifted with respect to the phase of the irradiation light according to the distance to the target object. When the distance measurement range in the CW-ToF sequence is denoted by df1, df1=c/f1.

Next, the calculation of the second estimated distance according to the pulse ToF method will be described. Signal processor 40, for example, calculates the second estimated distance based on the second pixel signal output from each pixel 21 in the pulse ToF sequence that includes first pulse emission and exposure period Sb1 and second pulse emission and exposure period Sb2 described above. The second estimated distance, which is denoted by d2, is calculated using Equation (2) below.

$$\begin{matrix}[ Math . 2 ] & \\ d 2 = \frac{c \times Tp 2}{2} \times \frac{P 1}{P 0 + P 1} & ( 2 )\end{matrix}$$

Equation (2) shown above is an equation used when pixel 21 receives, during exposure period P0 and exposure period P1, reflected light of the pulsed light that has reflected off the target object and has returned to pixel 21 with a delay of time At from the emission of the pulsed light by light source unit 10. In this case, P1 denotes the signal value corresponding to reflected light for time Δt, and P0 denotes the signal value corresponding to reflected light for time obtained by subtracting time Δt from Tp2. Of pulse width Tp2 of the pulsed light, the proportion of time Δt is P1/(P0+P1), and thus Δt=Tp2×P1/(P0+P1). Since the round-trip traveling time of the pulsed light for a distance to and from the target object is 2×Δt, d2 can be calculated using Equation (2) shown above.

Note that d2 is calculated using Equation (3) shown below when pixel 21 receives reflected light during exposure period P1 and exposure period P2.

$$\begin{matrix}[ Math . 3 ] & \\ d 2 = \frac{c \times Tp 2}{2} \times ( \frac{P 2}{P 1 + P 2} + 1 ) & ( 3 )\end{matrix}$$

Also, d2 is calculated using Equation (4) shown below when pixel 21 receives reflected light during exposure period P2 and exposure period P3.

$$\begin{matrix}[ Math . 4 ] & \\ d 2 = \frac{c \times Tp 2}{2} \times ( \frac{P 3}{P 2 + P 3} + 2 ) & ( 4 )\end{matrix}$$

Signal processor 40, for example, compares P0, P1, P2, and P3, and applies an equation that uses each of the signal values corresponding to two exposure periods whose total signal value is greatest among total signal values corresponding to two exposure periods that are different in start timing only by Tp2. Thus, when the distance measurement range in the pulse ToF sequence in the above example is denoted by df2, df2=(c×3×Tp2)/2.

In the equations shown above, among signal values P0, P1, P2, and P3, signal values not used for the calculation of d2 are signal values corresponding to background light incident on pixel 21 during the exposure periods irrespective of the reflected light. Therefore, in the above equations, the signal values not used for the calculation of d2 may be subtracted from the signal values corresponding to the reflected light.

Next, when df1 denotes the distance measurement range in the CW-ToF sequence and n denotes an integer greater than or equal to 0, signal processor 40 determines the smallest value of n among one or more values of n that result in the smallest difference between n×df1+d1 and second estimated distance d2.

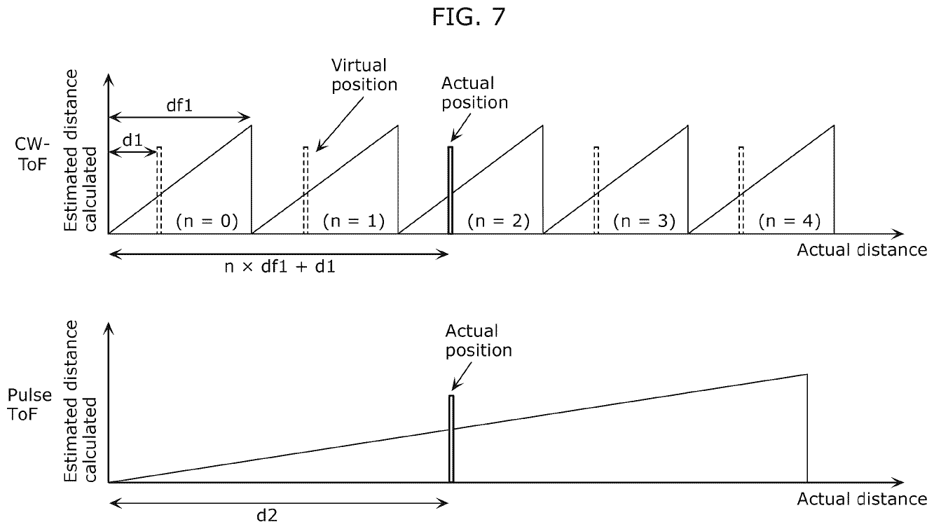

FIG. 7 is a diagram for describing estimated distances calculated using the CW-ToF method and the pulse ToF method. The upper portion of FIG. 7 illustrates, in the form of a solid-line graph, a relationship between the estimated distance calculated and the actual distance in the case of the CW-ToF method. That is to say, the graph in the upper portion of FIG. 7 illustrates a relationship between the actual distance and the first estimated distance calculated based on the first pixel signal output from pixel 21 in the CW-ToF sequence described above. The lower portion of FIG. 7 illustrates, in the form of a solid-line graph, a relationship between the estimated distance calculated and the actual distance in the case of the pulse ToF method. That is to say, the graph in the lower portion of FIG. 7 illustrates a relationship between the actual distance and the second estimated distance calculated based on the second pixel signal output from pixel 21 in the pulse ToF sequence described above. In these two graphs, the vertical axis represents the estimated distance calculated, and the horizontal axis represents the actual distance. Note that the scale for the vertical axis and the scale for the horizontal axis are not the same in these graphs; the horizontal axis has a greater scale.

As illustrated in FIG. 7, first estimated distance d1 calculated using the CW-ToF method does not exceed distance measurement range df1 in the CW-ToF sequence. With the CW-ToF method, the phase difference from 0 degrees to 360 degrees is repeated, and thus the distance is wrapped around for every distance measurement range df1. As a result, first estimated distance d1 calculated is repeated within distance measurement range df1 even if the actual distance is longer. Thus, even when the actual position of the target object is beyond distance measurement range df1, first estimated distance d1 calculated is a value less than distance measurement range df1. The value of n described above is equivalent to the number of times the distance is wrapped around for every distance measurement range df1, and one of virtual positions at which the distance from distance measuring device 100 can be expressed as n×df1+d1 is the actual position of the target object. The virtual positions other than the actual position are positions corresponding to false distances.

In contrast, with the pulse ToF method, a condition that does not substantially cause the distance wrap-around can be set, and the distance wrap-around is thus not likely to occur. Therefore, second estimated distance d2 calculated using the pulse ToF method normally corresponds to the actual position of the target object. Accordingly, a range-added first estimated distance is the distance corresponding to the actual position of the target object in the CW-ToF method. Here, the range-added first estimated distance is a distance obtained by adding, to the first estimated distance, a distance measurement range calculated by n×df1+d1 using the smallest value of n among one or more values of n that result in the smallest difference between n×df1+d1 and d2.

In view of the above, signal processor 40 determines, as the distance to the target object, one of (i) the range-added first estimated distance calculated by n×df1+d1 using the smallest value of n among one or more values of n that result in the smallest difference between n×df1+d1 and d2 or (ii) the second estimated distance. Signal processor 40, for example, determines, as the distance to the target object, the range-added first estimated distance calculated according to the CW-ToF method that is shorter in distance measurement range and higher in distance measurement accuracy than the pulse ToF method. In particular, since it is easy to increase the frequency of continuous-wave irradiation light such as the irradiation light in the CW-ToF method, the distance measurement accuracy can be easily enhanced.

### [Impact of Multipath]

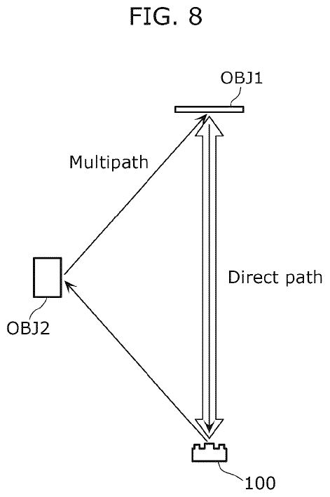

Next, the following describes the determination, by signal processor 40, of the distance to the target object with the impact of a multipath of the irradiation light taken into consideration. Multipath of the irradiation light is one factor that reduces the distance measurement accuracy in the indirect ToF method. FIG. 8 is a diagram for describing a multipath. The range-added first estimated distance and the second estimated distance that have been calculated above are not likely to be different from the true distance if the pulsed light emitted by light source unit 10 travels along the direct path where the pulsed light directly hits and reflects off intended target object OBJ1 as illustrated in FIG. 8. In reality, however, there could be a multipath where part of the pulsed light emitted by light source unit 10 reflects off different target object OBJ2 and then reflects off intended target object OBJ1. Although the number of multipaths is one in the example illustrated in FIG. 8, there could be a plurality of multipaths. The pulsed light traveling along the multipath returns to distance measuring device 100 later than the pulsed light traveling along the direct path. Thus, the distance corresponding to the time of flight of the pulsed light traveling along the multipath becomes longer than the true distance. In reality, reflected light that reflects off target object OBJ1 and returns to distance measuring device 100 includes a direct path component that travels along the direct path and a multipath component that travels along the multipath path, and thus, the range-added first estimated distance and the second estimated distance that have been calculated above contain errors that make them longer than the true distance.

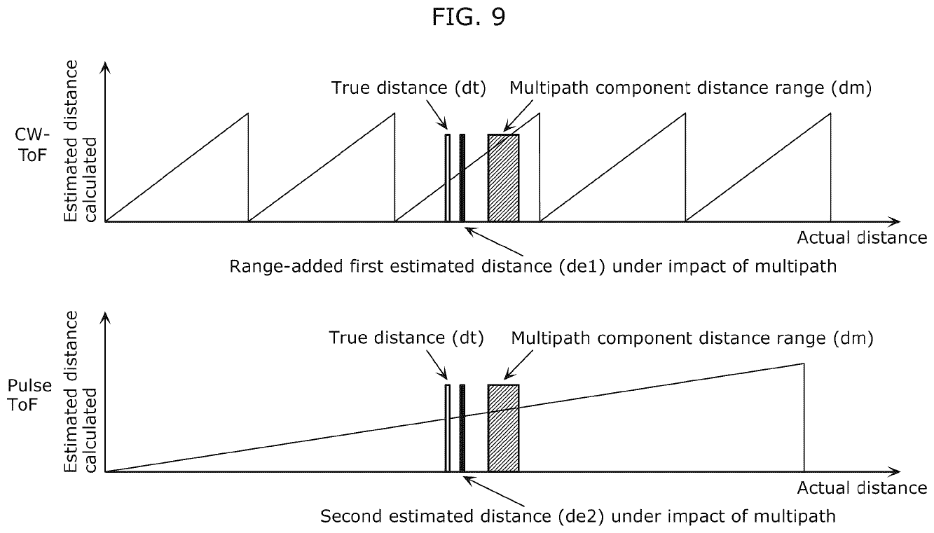

FIG. 9 is a first diagram for describing the impact that the multipath has on the estimated distances. FIG. 9 illustrates an example of the case where multipath component distance range dm is relatively narrow. Multipath component distance range dm is a virtual distance range corresponding to the time of flight of each multipath component when there are a plurality of multipaths. As in FIG. 7, FIG. 9 illustrates, in the form of solid-line graphs, relationships between the estimated distances calculated and the actual distance.

As illustrated in FIG. 9, multipath component distance range dm is longer than true distance dt. As a result, range-added first estimated distance de1 and second estimated distance de2 calculated under the impact of the multipath indicate values greater than true distance dt. When multipath component distance range dm is relatively narrow, multipath component distance range dm and true distance dt often fall within the width of distance measurement range df1 in the CW-ToF method. As illustrated in FIG. 9, when multipath component distance range dm and true distance dt fall within the width of distance measurement range df1, the impact that the multipath has on the estimated distances becomes equal between the CW-ToF method and the pulse ToF method, and range-added first estimated distance del and second estimated distance de2 indicate the same value.

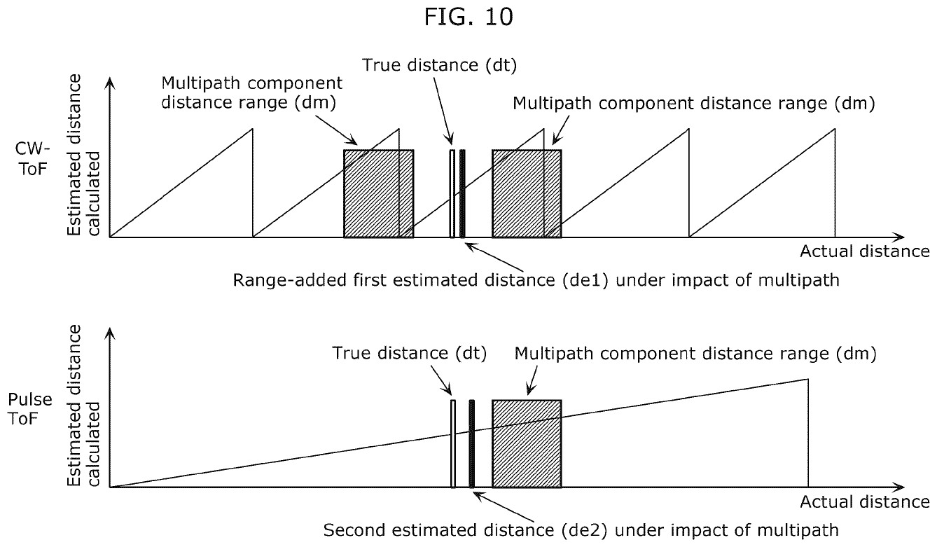

Next, the following describes the case where multipath component distance range dm is wider than in FIG. 9. FIG. 10 is a second diagram for describing the impact that the multipath has on the estimated distances. FIG. 10 illustrates an example of the case where multipath component distance range dm is relatively wide. As in FIG. 7, FIG. 10 illustrates, in the form of solid-line graphs, relationships between the estimated distances calculated and the actual distance.

When multipath component distance range dm is relatively wide, the cases where multipath component distance range dm does not fall within the width of distance measurement range df1 are likely to occur in the CW-ToF method. As illustrated in FIG. 10, when multipath component distance range dm does not fall within the width of distance measurement range df1, part of multipath component distance range dm wraps around toward the shorter distance side, and this part has such an impact on range-added first estimated distance del that range-added first estimated distance de1 becomes shorter. As a result, the impact that the multipath has on the estimated distances is different between the CW-ToF method and the pulse ToF method. By using range-added first estimated distance de1, which is likely to be shorter than second estimated distance de2, the value of a distance closer to true distance dt is derived as the distance to the target object. Accordingly, when signal processor 40 is to determine one of range-added first estimated distance de1 or second estimated distance de2 as the distance to the target object, the difference from true distance dt is usually likely to be smaller if, considering the impact of the multipath, range-added first estimated distance de1 is determined as the distance to the target object.

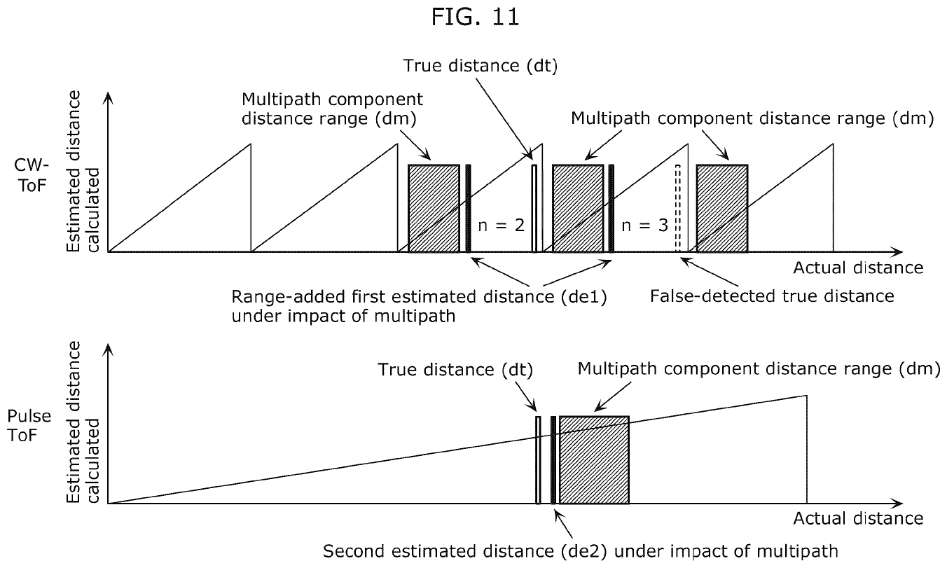

Next, the following describes the case where, in the CW-ToF method, half or more than half of multipath component distance range dm wraps around beyond distance measurement range df1. FIG. 11 is a third diagram for describing the impact that the multipath has on the estimated distances. As an extreme example of the case where half or more than half of multipath component distance range dm wraps around beyond distance measurement range df1, FIG. 11 illustrates an example of the case where multipath component distance range dm is relatively wide and multipath component distance range dm entirely wraps around toward the shorter distance side. As in FIG. 7, FIG. 11 illustrates, in the form of solid-line graphs, the relationships between the estimated distances calculated and the actual distance.

As illustrated in FIG. 11, with the CW-ToF method, when multipath component distance range dm entirely wraps around toward the shorter distance side, the difference between true distance dt and multipath component distance range dm becomes large within the width of repeating distance measurement range df1, and multipath component distance range dm becomes shorter than true distance dt. Therefore, range-added first estimated distance del becomes significantly shorter than true distance dt. Thus, even though true distance dt is within the width of distance measurement range df1 when n=2, the difference between range-added first estimated distance de1 and second estimated distance de2 becomes the smallest when n=3. If signal processor 40 determines range-added first estimated distance de1 as the distance to the target object in such a case, true distance dt is erroneously detected, resulting in a greater difference from true distance dt. Therefore, signal processor 40 determines, for example, second estimated distance de2 as the distance to the target object when second estimated distance de2 is shorter than range-added first estimated distance de1. This reduces the difference between the determined distance and true distance dt.

In view of the above, considering the impact of the multipath described using the examples illustrated in FIG. 9 through FIG. 11, the distance measurement accuracy can be enhanced by signal processor 40 determining a shorter one of second estimated distance de2 or range-added first estimated distance de1 as the distance to the target object. When second estimated distance de2 is shorter than range-added first estimated distance de1, signal processor 40 may determine that anomalous distance measurement has been performed. In that case, signal processor 40 outputs information indicating that anomalous distance measurement has been performed.

### [Advantageous Effects etc.]

As described above, distance measuring device 100 according to the present embodiment includes: light source unit 10 that emits irradiation light; light receiver 20 including pixel 21 that generates a pixel signal based on incident light; drive controller 30 that controls driving of light source unit 10 and light receiver 20; and signal processor 40 that derives a distance to a target object based on the pixel signal. Drive controller 30: drives light source unit 10 and pixel 21 through a CW-ToF sequence and a pulse ToF sequence that are sequences for measuring a distance using mutually different types of indirect ToF methods; and switches between the CW-ToF sequence and the pulse ToF sequence between frames. Signal processor 40 derives the distance to the target object based on a first pixel signal generated by pixel 21 in the CW-ToF sequence and a second pixel signal generated by pixel 21 in the pulse ToF sequence. Here, a distance measurement range in the pulse ToF sequence is longer than a distance measurement range in the CW-ToF sequence.

This enables distance measuring device 100 to derive the distance to the target object using: the first pixel signal generated through the CW-ToF sequence using the CW-ToF method that is shorter in distance measurement range and easier in enhancing the distance measurement accuracy than the pulse ToF method; and the second pixel signal generated through the pulse ToF sequence using the pulse ToF method that is not likely to cause distance wrap-around. In addition to the first pixel signal, the second pixel signal is also used for deriving the distance; therefore, the distance measurement range of distance measuring device 100 is expanded, and detection of a false distance is inhibited. Accordingly, distance measuring device 100 can achieve both expansion of the distance measurement range and improvement in the distance measurement accuracy.

In addition, a distance measuring method performed by distance measuring device 100 includes: driving light source unit 10 and pixel 21 through a CW-ToF sequence and a pulse ToF sequence that are sequences for measuring a distance using mutually different types of indirect ToF methods; and deriving a distance to a target object based on a first pixel signal generated by pixel 21 in the CW-ToF sequence and a second pixel signal generated by pixel 21 in the pulse ToF sequence. Here, a distance measurement range in the pulse ToF sequence is longer than a distance measurement range in the CW-ToF sequence.

This makes it possible to achieve the same advantageous effects as those achieved by distance measuring device 100 described above.

In addition, for example, drive controller 30: in the CW-ToF sequence, causes pixel 21 to be continuously exposed from the start of exposure of pixel 21 until the start of readout of the first pixel signal; and in the pulse ToF sequence, causes pixel 21 to be intermittently exposed from the start of exposure of pixel 21 until the start of readout of the second pixel signal.

According to this, the pulse ToF sequence includes, in a period from the start of exposure until the start of readout of the second pixel signal, a period in which the pixel is not exposed, thus making it possible to inhibit reflected light from being incident on the pixel during the exposure period corresponding to the next pulse of the emission control pulse, thereby further inhibiting occurrence of distance wrap-around.

In addition, for example, light source unit 10 emits pulsed light as the irradiation light according to an emission control pulse that is output from drive controller 30, and drive controller 30: in the CW-ToF sequence, outputs a first emission control pulse to light source unit 10 to cause light source unit 10 to emit pulsed light as the irradiation light, the first emission control pulse having a first duty cycle; and in the pulse ToF sequence, outputs a second emission control pulse to light source unit 10 to cause light source unit 10 to emit pulsed light as the irradiation light, the second emission control pulse having a second duty cycle.

According to this, the emission control pulse causes light source unit 10 to emit pulsed light in both the CW-ToF sequence and the pulse ToF sequence, thereby facilitating generation, by drive controller 30, of a control signal for controlling light source unit 10.

In addition, for example, the second duty cycle is less than the first duty cycle. In addition, for example, the second duty cycle is less than 50%. In addition, for example, the second duty cycle is less than 25%. In addition, for example, a pulse width of the second emission control pulse is greater than a pulse width of the first emission control pulse.

According to these, the distance measurement range in the pulse ToF sequence can be further expanded.

In addition, for example, signal processor 40: calculates a first estimated distance based on the first pixel signal; calculates a second estimated distance based on the second pixel signal; and determines, as the distance to the target object, one of (i) a range-added first estimated distance or (ii) the second estimated distance, the range-added first estimated distance being calculated by n×df1+d1 using a smallest value of n among one or more values of n that result in a smallest difference between n×df1+d1 and d2, where: d1 denotes the first estimated distance; d2 denotes the second estimated distance; df1 denotes the distance measurement range in the CW-ToF sequence; and n denotes an integer greater than or equal to 0.

According to this, since one of the range-added first estimated distance calculated using the CW-ToF method or the second estimated distance calculated using the pulse ToF method can be selected as the distance to the target object, it is possible to select an estimated distance that is more appropriate according to the situation.

In addition, for example, signal processor 40 determines, as the distance to the target object, a shorter one of the second estimated distance or the range-added first estimated distance.

According to this, even when the estimated distances calculated are longer than the true distance due to the impact of the multipath, the estimated distance having a smaller impact of the multipath is selected.

In addition, for example, when the second estimated distance is shorter than the range-added first estimated distance, signal processor 40 determines that anomalous distance measurement has been performed.

According to this, when the second estimated distance is shorter than the range-added first estimated distance due to incorrect reflection of the impact of the multipath, it is possible to determine that the distance measurement is anomalous and output the determination result.

In addition, for example, pixel 21 includes: photoelectric converter 22 that converts the incident light into signal charge; a plurality of charge accumulators 23a and 23b each of which accumulates the signal charge obtained by the conversion performed by photoelectric converter 22; a plurality of charge transferers 24a and 24b that transfer, to the plurality of charge accumulators 23a and 23b, the signal charge obtained by the conversion performed by photoelectric converter 22, the plurality of charge transferers 24a and 24b corresponding one-on-one to the plurality of charge accumulators 23a and 23b; charge drainer 25 that drains the signal charge obtained by the conversion performed by photoelectric converter 22; and drain controller 26 that controls draining of the signal charge performed by charge drainer 25.

According to this, charge drainer 25 and drain controller 26 can drain signal charge generated by photoelectric converter 22, thus easily realizing a non-exposure period of pixel 21.

### [Different Examples of Drive Sequence]

Next, different examples of the drive sequence of distance measuring device 100 according to the present embodiment will be described. The following description of different examples of the drive sequence will focus on the differences from the drive sequence described above, and omit or simplify the description of common points.

First, a first different example of the drive sequence will be described. FIG. 12 is a diagram illustrating the first different example of the drive sequence of distance measuring device 100 according to the embodiment.

In the example illustrated in FIG. 12, the CW-ToF sequence includes first CW-ToF frame Fa1 and second CW-ToF frame Fa2 and is made up of these two types of frames as in the example illustrated in FIG. 4.

In the example illustrated in FIG. 12, the pulse ToF sequence: includes first pulse ToF frame Fb1 in which each pixel 21 is exposed at a predetermined timing with respect to the timing at which light source unit 10 emits the irradiation light; and is made up of this one type of frame.

In the example illustrated in FIG. 12, drive controller 30 repeats, for a predetermined number of times, a set including first CW-ToF frame Fa1, second CW-ToF frame Fa2, and first pulse ToF frame Fb1. In each set, the total number of frames of each type is one. This set of frames is the unit of repetition. In the example illustrated in FIG. 12, first CW-ToF frame Fa1, second CW-ToF frame Fa2, and first pulse ToF frame Fb1 are repeated in the stated order; however, the order of frames in the unit of repetition is not particularly limited.

As indicated from above, the drive sequence illustrated in FIG. 12 has a configuration obtained by excluding second pulse ToF frame Fb2 from the drive sequence illustrated in FIG. 4. Therefore, the time length of the drive sequence necessary for deriving the distance can be reduced, making it possible to capture a distance measurement image with motion blur inhibited. Also, since the pulse ToF sequence illustrated in FIG. 12 is made up of first pulse ToF frame Fb1, the second estimated distance is calculated using Equation (2) only, among Equations (2), (3), and (4) shown above. Thus, the distance measurement range in the pulse ToF sequence illustrated in FIG. 12 is (c×Tp2)/2, but if pulse width Tp2 is set greater than that of the pulse ToF sequence illustrated in FIG. 4, the distance measurement range in the pulse ToF sequence illustrated in FIG. 12 can be equivalent to the distance measurement range of the pulse ToF sequence illustrated in FIG. 4. Note that the method of deriving the distance to the target object using the first estimated distance and the second estimated distance in the drive sequence illustrated in FIG. 12 is the same as the method used in the case of the drive sequence illustrated in FIG. 4 described above.

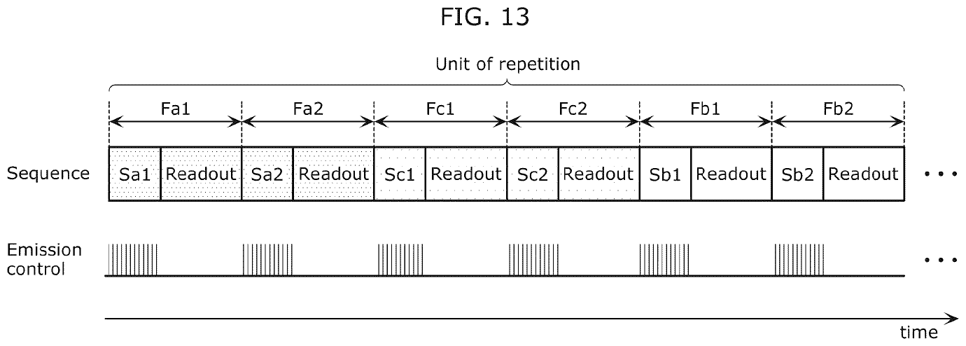

Next, a second different example of the drive sequence will be FIG. 13 is a diagram illustrating the second different described. example of the drive sequence of distance measuring device 100 according to the embodiment.

The drive sequence illustrated in FIG. 13 has a configuration obtained by adding another CW-ToF sequence to the drive sequence illustrated in FIG. 4. In FIG. 13, the other CW-ToF sequence is represented by a rectangle that is dotted less densely than the dotted rectangle representing the CW-ToF sequence. In the example illustrated in FIG. 13, drive controller 30 drives light source unit 10 and each pixel 21 through the CW-ToF sequence, the other CW-ToF sequence, and the pulse ToF sequence that are time-divided. The distance measurement range of the other CW-ToF sequence is longer than the distance measurement range of the CW-ToF sequence.

In the example illustrated in FIG. 13, the other CW-ToF sequence: includes first CW-ToF frame Fc1 and second CW-ToF frame Fc2 that are mutually different in timing at which each pixel 21 is exposed with respect to the timing at which light source unit 10 emits the irradiation light; and is made up of these two types of frames. First CW-ToF frame Fc1 includes first CW emission and exposure period Sc1 and a readout period that follows first CW emission and exposure period Sc1. Second CW-ToF frame Fc2 includes second CW emission and exposure period Sc2 and a readout period that follows second CW emission and exposure period Sc2. During the readout periods of the other CW-ToF sequence, a third pixel signal generated by each pixel 21 is read out.

In the example illustrated in FIG. 13, drive controller 30 repeats, for a predetermined number of times, a set including first CW-ToF frame Fa1, second CW-ToF frame Fa2, first CW-ToF frame Fc1, second CW-ToF frame Fc2, first pulse ToF frame Fb1, and second pulse ToF frame Fb2. In each set, the total number of frames of each type is one. This set of frames is the unit of repetition. In the example illustrated in FIG. 13, first CW-ToF frame Fa1, second CW-ToF frame Fa2, first CW-ToF frame Fc1, second CW-ToF frame Fc2, first pulse ToF frame Fb1, and second pulse ToF frame Fb2 are repeated in the stated order; however, the order of frames in the unit of repetition is not particularly limited.

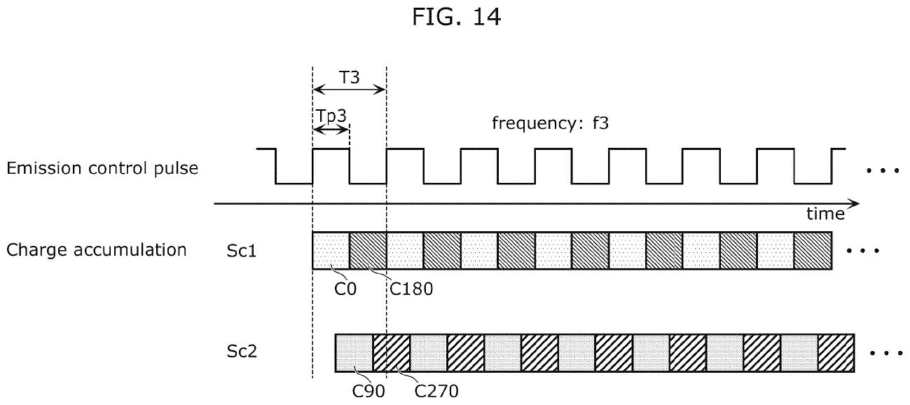

FIG. 14 is a timing diagram illustrating an example of first CW emission and exposure period Sc1 and second CW emission and exposure period Sc2.

“Emission control pulse” in FIG. 14 shows an example of a third emission control pulse output by drive controller 30 to light source unit 10 during first CW emission and exposure period Sc1 and second CW emission and exposure period Sc2 (that is, the waveform of the irradiation light emitted by light source unit 10). The third emission control pulse output during first CW emission and exposure period Sc1 and the third emission control pulse output during second CW emission and exposure period Sc2 have the same waveform.

During first CW emission and exposure period Sc1 and second CW emission and exposure period Sc2, drive controller 30 outputs the third emission control pulse having a third duty cycle to light source unit 10 to cause light source unit 10 to emit pulsed light as the irradiation light. In the example illustrated in FIG. 14, the frequency of the third emission control pulse is f3. The pulse width of the third emission control pulse is Tp3, and the cycle of the third emission control pulse is T3. Thus, the third duty cycle of the third emission control pulse is Tp3/T3. In the example illustrated in FIG. 14, the third duty cycle is 50%; however, the distance measurement using the CW-ToF method is possible so long as the third duty cycle is at least 25% and at most 75%. Frequency f3 of the third emission control pulse is lower than frequency f1 of the first emission control pulse. That is to say, f1>f3. Also, a1×f1=a3×f3, where a1 and a3 are mutually different natural numbers.

“Charge accumulation” in FIG. 14 shows exposure periods C0, C90, C180, and C270 during which drive controller 30 causes each pixel 21 to be exposed and accumulate signal charge. Exposure periods C0, C90, C180, and C270 in first CW emission and exposure period Sc1 and second CW emission and exposure period Sc2 are set to periods associated with the third emission control pulse. Apart from this difference, the driving performed during exposure periods C0, C90, C180, and C270 in first CW emission and exposure period Sc1 and second CW emission and exposure period Sc2 is the same as the driving performed during exposure periods C0, C90, C180, and C270 in first CW emission and exposure period Sa1 and second CW emission and exposure period Sa2 described with reference to FIG. 5.

First CW emission and exposure period Sc1 includes exposure period C0 and exposure period C180, and exposure period C0 and exposure period C180 are alternately repeated in a continuous manner until the readout period starts. Exposure period C0 starts at a timing when the phase difference from the third emission control pulse is 0 degrees, and exposure period C180 starts at a timing when the phase difference from the third emission control pulse is 180 degrees. The total length of exposure period C0 and exposure period C180 is the same as cycle T3 of the third emission control pulse.

Second CW emission and exposure period Sc2 includes exposure period C90 and exposure period C270, and exposure period C90 and exposure period C270 are alternately repeated in a continuous manner until the readout period starts. Exposure period C90 starts at a timing when the phase difference from the third emission control pulse is 90 degrees, and exposure period C270 starts at a timing when the phase difference from the third emission control pulse is 270 degrees. The total length of exposure period C90 and exposure period C270 is the same as cycle T3 of the third emission control pulse.

Exposure period C0, exposure period C180, exposure period C90, and exposure period C270 are equal in length, that is, the length of each period is the cycle of the third emission control pulse divided by 2, namely T3/2. During each of first CW emission and exposure period Sc1 and second CW emission and exposure period Sc2, drive controller 30 causes each pixel 21 to be continuously exposed from the start of exposure of each pixel 21 until the start of readout of the third pixel signal. Note that an interval may be provided between the end of exposure of each pixel 21 and the start of readout of the third pixel signal.

In the drive sequence illustrated in FIG. 13, signal processor 40 derives the distance to the target object based on the first pixel signal, the second pixel signal, and the third pixel signal. Specifically, in deriving the distance to the target object, signal processor 40 first calculates, based on the third pixel signal, a third estimated distance using the distance computation according to the CW-ToF method, in addition to the calculation of the first estimated distance and the second estimated distance described above. Signal processor 40 derives the distance to the target object based on the first estimated distance, the second estimated distance, and the third estimated distance. For example, signal processor 40 calculates the third estimated distance based on the third pixel signal output from each pixel 21 in the other CW-ToF sequence that includes first CW emission and exposure period Sc1 and second CW emission and exposure period Sc2 described above. The third estimated distance, which is denoted by d3, is calculated using Equation (5) below.

$$\begin{matrix}[ Math . 5 ] & \\ d 3 = \frac{c}{4 π f 3} arctan \frac{C 90 - C 270}{C 0 - C 180} & ( 5 )\end{matrix}$$

As with Equation (1), Equation (5) shown above is an equation for calculating a distance using the phenomenon that the phase of reflected light of the irradiation light that has reflected off the target object is shifted with respect to the phase of the irradiation light according to the distance to the target object. When the distance measurement range in the other CW-ToF sequence is denoted by df3, df3=c/f3.

Next, when df1 denotes the distance measurement range in the CW-ToF sequence and m1 denotes an integer greater than or equal to 0, and when df3 denotes the distance measurement range in the other CW-ToF sequence and m3 denotes an integer greater than or equal to 0, signal processor 40 determines a pair of the smallest value of m1 and the smallest value of m3 among pairs of m1 and m3 that result in the smallest difference between m1×df1+d1 and m3×df3+d3. Signal processor 40 then determines the smallest value of n among one or more values of n that result in the smallest difference between n×m1×df1+d1 and second estimated distance d2. In the drive sequence illustrated in FIG. 13, the unit of wrap-around of the estimated distance calculated using the CW-ToF method is m1×df1, that is, expanded, thus making it possible to inhibit erroneous determination in the determination of the value of n, as compared to the drive sequence illustrated in FIG. 4.

Finally, signal processor 40 determines, as the distance to the target object, one of (i) the range-added first estimated distance calculated by n×m1×df1+d1 using the smallest value of n among one or more values of n that result in the smallest difference between n×m1×df1+d1 and d2 or (ii) second estimated distance d2. Whether signal processor 40 selects the range-added first estimated distance or selects the second estimated distance is the same as that in the case of the drive sequence illustrated in FIG. 4.

Note that in the drive sequence illustrated in FIG. 13, further another CW-ToF sequence in which an emission control pulse is output with a frequency different from frequency f1 and frequency f3 may be added. This further expands the unit of wrap-around of the estimated distance calculated using the CW-ToF method, thus making it possible to further inhibit erroneous determination in the determination of the value of n. The drive sequence of distance measuring device 100 may further include another pulse ToF sequence having a distance measurement range different from the distance measurement range of the pulse ToF sequence. During the emission and exposure period of the other pulse ToF sequence, drive controller 30, for example, outputs an emission control pulse different from the second emission control pulse in at least one of the duty cycle, the pulse width, or the cycle, and causes each pixel 21 to be exposed during the exposure period at the timing corresponding to the emission control pulse.

Distance measuring device 100 according to the present embodiment may operate with a single, fixed drive sequence, or may be switchably operate with a plurality of drive sequences. For example, distance measuring device 100 may be a device that operates with only one of the drive sequences illustrated in FIG. 4, FIG. 12, and FIG. 13, or may be a device that operates while switching between two or more of such drive sequences.

### [Variation 1]

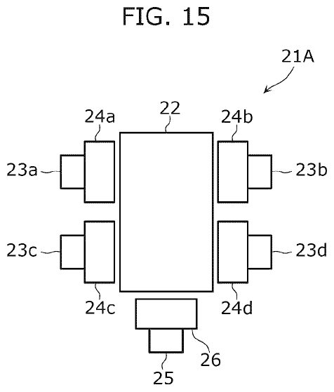

Next, Variation 1 of the embodiment will be described. The following description of Variation 1 will focus on the differences from the embodiment, and omit or simplify the description of common points. FIG. 15 is a plan view illustrating an example of a configuration of pixel 21A according to the present variation. The distance measuring device according to the present variation has a configuration in which pixels 21 of distance measuring device 100 according to the embodiment are replaced with pixels 21A.

Pixel 21A and pixel 21 are different in total numbers of charge accumulators and charge transferers. Pixel 21A has four charge accumulators and four charge transferers. Specifically, each pixel 21A includes photoelectric converter 22, a plurality of charge accumulators 23a, 23b, 23c, and 23d, a plurality of charge transferers 24a, 24b, 24c, and 24d, charge drainer 25, and drain controller 26. Charge transferer 24c transfers signal charge to charge accumulator 23c, and charge transferer 24d transfers signal charge to charge accumulator 23d.

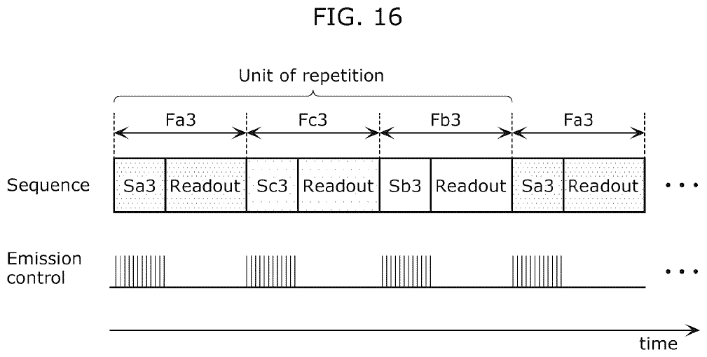

Next, a drive sequence of the distance measuring device according to the present variation will be described. FIG. 16 is a diagram illustrating an example of the drive sequence of the distance measuring device according to the present variation.

In the example illustrated in FIG. 16, drive controller 30 drives light source unit 10 and each pixel 21A through a CW-ToF sequence, another CW-ToF sequence, and a pulse ToF sequence that are time-divided. In FIG. 16, the other CW-ToF sequence is represented by a rectangle that is dotted less densely than the dotted rectangle representing the CW-ToF sequence. The distance measurement range of the other CW-ToF sequence is longer than the distance measurement range of the CW-ToF sequence.

In the example illustrated in FIG. 16, the CW-ToF sequence: includes first CW-ToF frame Fa3 in which each pixel 21A is exposed at a predetermined timing with respect to the timing at which light source unit 10 emits the irradiation light; and is made up of this one type of frame. First CW-ToF frame Fa3 includes first CW emission and exposure period Sa3 and a readout period that follows first CW emission and exposure period Sa3.

In the example illustrated in FIG. 16, the other CW-ToF sequence: includes first CW-ToF frame Fc3 in which each pixel 21A is exposed at a predetermined timing with respect to the timing at which light source unit 10 emits the irradiation light; and is made up of this one type of frame. First CW-ToF frame Fc3 includes first CW emission and exposure period Sc3 and a readout period that follows first CW emission and exposure period Sc3.

In the example illustrated in FIG. 16, the pulse ToF sequence: includes first pulse ToF frame Fb3 in which each pixel 21A is exposed at a predetermined timing with respect to the timing at which light source unit 10 emits the irradiation light; and is made up of this one type of frame. First pulse ToF frame Fb3 includes first pulse emission and exposure period Sb3 and a readout period that follows first pulse emission and exposure period Sb3.

Drive controller 30 repeats, for a predetermined number of times, a set including first CW-ToF frame Fa3, first CW-ToF frame Fc3, and first pulse ToF frame Fb3. In each set, the total number of frames of each type is one. This set of frames is the unit of repetition. Therefore, as compared to the drive sequence illustrated in FIG. 13, the time length of the drive sequence necessary for deriving the distance can be reduced, making it possible to capture a distance measurement image with motion blur inhibited. In the example illustrated in FIG. 16, first CW-ToF frame Fa3, first CW-ToF frame Fc3, and first pulse ToF frame Fb3 are repeated in the stated order; however, the order of frames in the unit of repetition is not particularly limited.

Next, the details of first CW emission and exposure period Sa3, first CW emission and exposure period Sc3, and first pulse emission and exposure period Sb3 will be described.

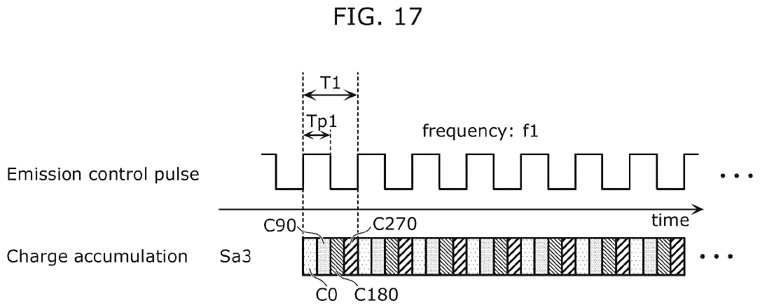

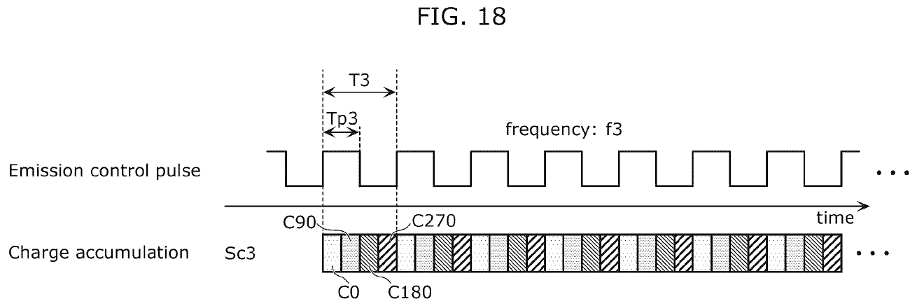

First, first CW emission and exposure period Sa3 included in the CW-ToF sequence will be described. FIG. 17 is a timing diagram illustrating an example of first CW emission and exposure period Sa3.

“Emission control pulse” in FIG. 17 shows an example of a first emission control pulse output by drive controller 30 to light source unit 10 during first CW emission and exposure period Sa3. The first emission control pulse output during first CW emission and exposure period Sa3 is the same as the first emission control pulse output during first CW emission and exposure period Sa1 and second CW emission and exposure period Sa2 illustrated in FIG. 5.

“Charge accumulation” in FIG. 17 shows exposure periods C0, C90, C180, and C270 during which drive controller 30 causes each pixel 21A to be exposed and accumulate signal charge. Specifically, drive controller 30 outputs the exposure control pulse to each pixel 21A during exposure periods C0, C90, C180, and C270 to turn on one of charge transferers 24a, 24b, 24c, and 24d to cause the one of charge transferers 24a, 24b, 24c, and 24d to transfer signal charge from photoelectric converter 22 to a corresponding one of charge accumulator 23a, 23b, 23c, and 23d. Exposure periods C0, C90, C180, and C270 are set to periods associated with the first emission control pulse. The phase differences between the first emission control pulse and the start timings of exposure periods C0, C90, C180, and C270 are the same as the phase differences in first CW emission and exposure period Sa1 and second CW emission and exposure period Sa2 illustrated in FIG. 5.

First CW emission and exposure period Sa3 includes exposure period C0, exposure period C90, exposure period C180, and exposure period C270 that are continuously repeated in the stated order until the readout period starts. In first CW emission and exposure period Sa3, the total length of exposure period C0, exposure period C90, exposure period C180, and exposure period C270 is the same as cycle T1 of the first emission control pulse.

In first CW emission and exposure period Sa3, the charge accumulator that accumulates signal charge during exposure period C0, the charge accumulator that accumulates signal charge during exposure period C90, the charge accumulator that accumulates signal charge during exposure period C180, and the charge accumulator that accumulates signal charge during exposure period C270 are mutually different. For example, during exposure period C0, charge transferer 24a is turned on and signal charge is accumulated in charge accumulator 23a. During exposure period C90, charge transferer 24b is turned on and signal charge is accumulated in charge accumulator 23b. During exposure period C180, charge transferer 24c is turned on and signal charge is accumulated in charge accumulator 23c. During exposure period C270, charge transferer 24d is turned on and signal charge is accumulated in charge accumulator 23d.

During the readout period following first CW emission and exposure period Sa3, a signal based on the signal charge accumulated during exposure period C0, a signal based on the signal charge accumulated during exposure period C90, a signal based on the signal charge accumulated during exposure period C180, and a signal based on the signal charge accumulated during exposure period C270 are each read out as the first pixel signal.

In first CW emission and exposure period Sa3, exposure period C0, exposure period C180, exposure period C90, and exposure period C270 are equal in length, that is, the length of each period is the cycle of the first emission control pulse divided by 4, namely T1/4. During first CW emission and exposure period Sa3, drive controller 30 causes each pixel 21A to be continuously exposed from the start of exposure of each pixel 21A until the start of readout of the first pixel signal.

Note that first CW emission and exposure period Sa3 is not limited to the example illustrated in FIG. 17. For example, exposure period C0 and exposure period C180 may be alternately repeated in the first half of first CW emission and exposure period Sa3, and exposure period C90 and exposure period C270 may be alternately repeated in the second half of first CW emission and exposure period Sa3. In this case, the length of each of exposure period C0, exposure period C180, exposure period C90, and exposure period C270 is the cycle of the first emission control pulse divided by 2, namely T1/2.

Next, first CW emission and exposure period Sc3 included in the other CW-ToF sequence will be described. FIG. 18 is a timing diagram illustrating an example of first CW emission and exposure period Sc3.

“Emission control pulse” in FIG. 18 shows an example of a third emission control pulse output by drive controller 30 to light source unit 10 during first CW emission and exposure period Sc3. The third emission control pulse output during first CW emission and exposure period Sc3 is the same as the third emission control pulse output during first CW emission and exposure period Sc1 and second CW emission and exposure period Sc2 illustrated in FIG. 14.

“Charge accumulation” in FIG. 18 shows exposure periods C0, C90, C180, and C270 during which drive controller 30 causes each pixel 21A to be exposed and accumulate signal charge. Exposure periods C0, C90, C180, and C270 in first CW emission and exposure period Sc3 are set to periods associated with the third emission control pulse. Apart from this difference, the driving performed during exposure periods C0, C90, C180, and C270 in first CW emission and exposure period Sc3 is the same as the driving performed during exposure periods C0, C90, C180, and C270 in first CW emission and exposure period Sa3 described with reference to FIG. 17.

During the readout period following first CW emission and exposure period Sc3, a signal based on the signal charge accumulated during exposure period C0, a signal based on the signal charge accumulated during exposure period C90, a signal based on the signal charge accumulated during exposure period C180, and a signal based on the signal charge accumulated during exposure period C270 are each read out as the third pixel signal.

In first CW emission and exposure period Sc3, exposure period C0, exposure period C180, exposure period C90, and exposure period C270 are equal in length, that is, the length of each period is the cycle of the third emission control pulse divided by 4, namely T3/4. During first CW emission and exposure period Sc3, drive controller 30 causes each pixel 21A to be continuously exposed from the start of exposure of each pixel 21A until the start of readout of the third pixel signal.

Note that first CW emission and exposure period Sc3 is not limited to the example illustrated in FIG. 18. For example, exposure period C0 and exposure period C180 may be alternately repeated in the first half of first CW emission and exposure period Sc3, and exposure period C90 and exposure period C270 may be alternately repeated in the second half of first CW emission and exposure period Sc3. In this case, the length of each of exposure period C0, exposure period C180, exposure period C90, and exposure period C270 is the cycle of the third emission control pulse divided by 2, namely T3/2.

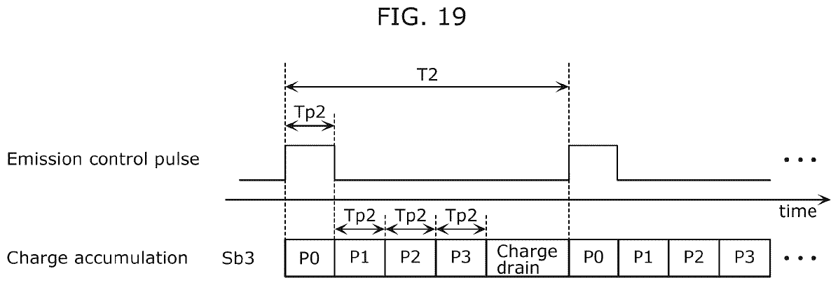

Next, first pulse emission and exposure period Sb3 included in the pulse ToF sequence will be described. FIG. 19 is a timing diagram illustrating an example of first pulse emission and exposure period Sb3. “Emission control pulse” in FIG. 19 shows an example of a second emission control pulse output by drive controller 30 to light source unit 10 during first pulse emission and exposure period Sb3. The second emission control pulse output during first pulse emission and exposure period Sb3 is the same as the second emission control pulse output during first pulse emission and exposure period Sb1 and second pulse emission and exposure period Sb2 illustrated in FIG. 6.

“Charge accumulation” in FIG. 19 shows: exposure periods P0, P1, P2, and P3 during which drive controller 30 causes each pixel 21A to be exposed and accumulate signal charge; and a charge drain period in which drive controller 30 causes the signal charge generated by photoelectric converter 22 of each pixel 21A to be drained. Specifically, drive controller 30 outputs the exposure control pulse to each pixel 21A during the exposure periods to turn on one of charge transferers 24a, 24b, 24c, and 24d and cause the one of charge transferers 24a, 24b, 24c, and 24d to transfer signal charge from photoelectric converter 22 to a corresponding one of charge accumulators 23a, 23b, 23c, and 23d. Exposure periods P0, P1, P2, and P3 are set to periods associated with the second emission control pulse. The relationships between the second emission control pulse and the start timings of exposure periods P0, P1, P2, and P3 are the same as the relationships in first pulse emission and exposure period Sb1 and second pulse emission and exposure period Sb2 illustrated in FIG. 6.

First pulse emission and exposure period Sb3 includes exposure period P0, exposure period P1, exposure period P2, exposure period P3, and a charge drain period that are repeated in the stated order until the readout period starts. The total length of exposure period P0, exposure period P1, exposure period P2, exposure period P3, and the charge drain period is the same as cycle T2 of the second emission control pulse.

In first pulse emission and exposure period Sb3, the charge accumulator that accumulates signal charge during exposure period P0, the charge accumulator that accumulates signal charge during exposure period P1, the charge accumulator that accumulates signal charge during exposure period P2, and the charge accumulator that accumulates signal charge during exposure period P3 are mutually different. For example, during exposure period P0, charge transferer 24a is turned on and signal charge is accumulated in charge accumulator 23a. During exposure period P1, charge transferer 24b is turned on and signal charge is accumulated in charge accumulator 23b. During exposure period P2, charge transferer 24c is turned on and signal charge is accumulated in charge accumulator 23c. During exposure period P3, charge transferer 24d is turned on and signal charge is accumulated in charge accumulator 23d.

During the readout period following first pulse emission and exposure period Sb3, a signal based on the signal charge accumulated during exposure period P0, a signal based on the signal charge accumulated during exposure period P1, a signal based on the signal charge accumulated during exposure period P2, and a signal based on the signal charge accumulated during exposure period P3 are each read out as the second pixel signal.

During first pulse emission and exposure period Sb3, drive controller 30 causes each pixel 21A to be intermittently exposed from the start of exposure of each pixel 21A until the start of the readout of the second pixel signal.

The derivation of the distance to the target object, performed by signal processor 40 according to the present variation, is the same as the derivation performed in the case of the drive sequence illustrated in FIG. 13.

Note that the drive sequence illustrated in FIG. 16 need not include the other CW-ToF sequence that includes first CW-ToF frame Fc3.

The distance measuring device according to the present variation is also capable of operating with the above-described drive sequence that distance measuring device 100 according to the embodiment operates with.

### [Variation 2]

Next, Variation 2 of the embodiment will be described. The following description of Variation 2 will focus on the differences from the embodiment and Variation 1, and omit or simplify the description of common points.

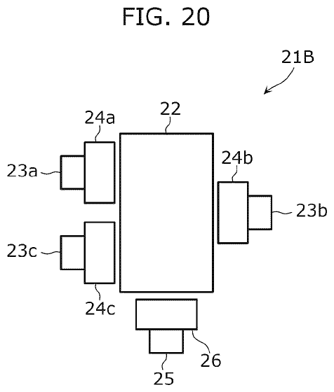

FIG. 20 is a plan view illustrating an example of a configuration of pixel 21B according to the present variation. The distance measuring device according to the present variation has a configuration in which pixels 21 of distance measuring device 100 according to the embodiment are replaced with pixels 21B.

Pixel 21B and pixel 21 are different in total numbers of charge accumulators and charge transferers. Pixel 21B has three charge accumulators and three charge transferers. Specifically, each pixel 21B includes photoelectric converter 22, a plurality of charge accumulators 23a, 23b, and 23c, a plurality of charge transferers 24a, 24b, and 24c, charge drainer 25, and drain controller 26.

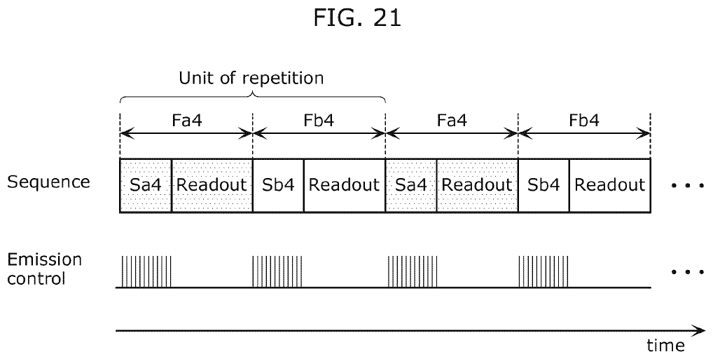

Next, a drive sequence of the distance measuring device according to the present variation will be described. FIG. 21 is a diagram illustrating an example of the drive sequence of the distance measuring device according to the present variation.

In the example illustrated in FIG. 21, drive controller 30 drives light source unit 10 and each pixel 21B through a CW-ToF sequence and a pulse ToF sequence that are time-divided.

In the example illustrated in FIG. 21, the CW-ToF sequence: includes first CW-ToF frame Fa4 in which each pixel 21B is exposed at a predetermined timing with respect to the timing at which light source unit 10 emits the irradiation light; and is made up of this one type of frame. First CW-ToF frame Fa4 includes first CW emission and exposure period Sa4 and a readout period following first CW emission and exposure period Sa4.

In the example illustrated in FIG. 21, the pulse ToF sequence: includes first pulse ToF frame Fb4 in which each pixel 21B is exposed at a predetermined timing with respect to the timing at which light source unit 10 emits the irradiation light; and is made up of this one type of frame. First pulse ToF frame Fb4 includes first pulse emission and exposure period Sb4 and a readout period that follows first pulse emission and exposure period Sb4.

Drive controller 30 repeats, for a predetermined number of times, a set including first CW-ToF frame Fa4 and first pulse ToF frame Fb4. In each set, the total number of frames of each type is one. This set of frames is the unit of repetition. Therefore, as compared to the drive sequence illustrated in FIG. 4, the time length of the drive sequence necessary for deriving the distance can be reduced, making it possible to capture a distance measurement image with motion blur inhibited.

In the example illustrated in FIG. 21, first CW-ToF frame Fa4 and first pulse ToF frame Fb4 are repeated in the stated order; however, the order of frames in the unit of repetition is not particularly limited.

Next, the details of first CW emission and exposure period Sa4 and first pulse emission and exposure period Sb4 will be described.

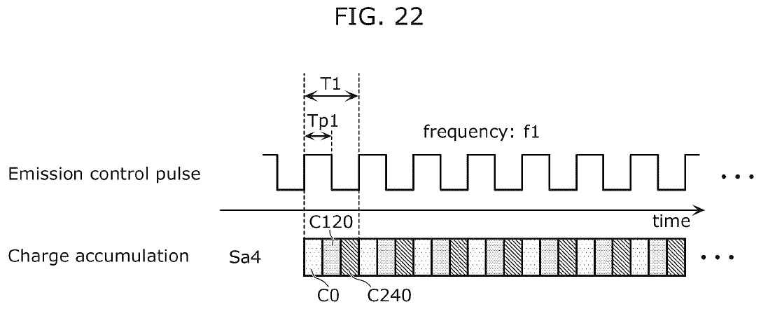

First, first CW emission and exposure period Sa4 included in the CW-ToF sequence will be described. FIG. 22 is a timing diagram illustrating an example of first CW emission and exposure period Sa4.

“Emission control pulse” in FIG. 22 shows an example of a first emission control pulse output by drive controller 30 to light source unit 10 during first CW emission and exposure period Sa4. The first emission control pulse output during first CW emission and exposure period Sa4 is the same as the first emission control pulse output during first CW emission and exposure period Sa1 and second CW emission and exposure period Sa2 illustrated in FIG. 5. In the example illustrated in FIG. 22, the first duty cycle of the first emission control pulse is 50%; however, the distance measurement using the CW-ToF method according to the present variation is possible so long as the first duty cycle is at least (100/3)% and at most (200/3)%.

“Charge accumulation” in FIG. 22 shows exposure periods C0, C120, and C240 during which drive controller 30 causes each pixel 21B to be exposed and accumulate signal charge. Specifically, drive controller 30 outputs the exposure control pulse to each pixel 21B during exposure periods C0, C120, and C240 to turn on one of charge transferers 24a, 24b, and 24c and cause the one of charge transferers 24a, 24b, and 24c to transfer signal charge from photoelectric converter 22 to a corresponding one of charge accumulators 23a, 23b, and 23c. Exposure periods C0, C120, and C240 are set to periods associated with the first emission control pulse.

First CW emission and exposure period Sa4 includes exposure period C0, exposure period C120, and exposure period C240 that are continuously repeated in the stated order until the readout period starts. In FIG. 22, densely dotted rectangles each represent exposure period C120, less densely dotted rectangles each represent exposure period C0, and shaded rectangles each represent exposure period C240. Exposure period C0 starts at a timing when the phase difference from the first emission control pulse is 0 degrees. Exposure period C120 starts at a timing when the phase difference from the first emission control pulse is 120 degrees. Exposure period C240 starts at a timing when the phase difference from the first emission control pulse is 240 degrees. The total length of exposure period C0, exposure period C120, and exposure period C240 is the same as cycle T1 of the first emission control pulse.

The charge accumulator that accumulates signal charge during exposure period C0, the charge accumulator that accumulates signal charge during exposure period C120, and the charge accumulator that accumulates signal charge during exposure period C240 are mutually different. For example, during exposure period C0, charge transferer 24a is turned on and signal charge is accumulated in charge accumulator 23a. During exposure period C120, charge transferer 24b is turned on and signal charge is accumulated in charge accumulator 23b. During exposure period C240, charge transferer 24c is turned on and signal charge is accumulated in charge accumulator 23c.

During the readout period following first CW emission and exposure period Sa4, a signal based on the signal charge accumulated during exposure period C0, a signal based on the signal charge accumulated during exposure period C120, and a signal based on the signal charge accumulated during exposure period C240 are each read out as the first pixel signal. Hereinafter, C0 denotes the signal value of the signal corresponding to exposure period C0, C120 denotes the signal value of the signal corresponding to exposure period C120, and C240 denotes the signal value of the signal corresponding to exposure period C240.

Exposure period C0, exposure period C120, and exposure period C240 are equal in length, that is, the length of each period is the cycle of the first emission control pulse divided by 3, namely T1/3. During first CW emission and exposure period Sa4, drive controller 30 causes each pixel 21B to be continuously exposed from the start of exposure of each pixel 21B until the start of readout of the first pixel signal.

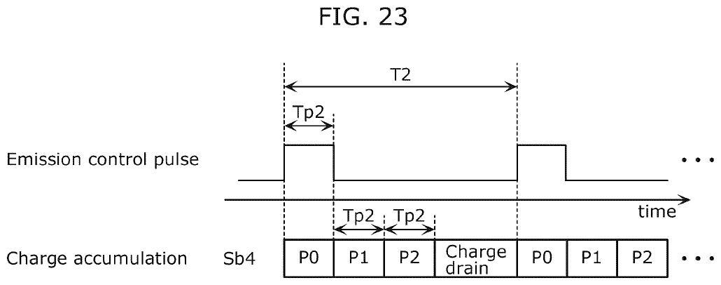

Next, first pulse emission and exposure period Sb4 included in the pulse ToF sequence will be described. FIG. 23 is a timing diagram illustrating an example of first pulse emission and exposure period Sb4.

“Emission control pulse” in FIG. 23 shows an example of a second emission control pulse output by drive controller 30 to light source unit 10 during first pulse emission and exposure period Sb4. The second emission control pulse output during first pulse emission and exposure period Sb4 is the same as the second emission control pulse output during first pulse emission and exposure period Sb1 and second pulse emission and exposure period Sb2 illustrated in FIG. 6.

“Charge accumulation” in FIG. 23 shows: exposure periods P0, P1, and P2 during which drive controller 30 causes each pixel 21B to be exposed and accumulate signal charge; and a charge drain period in which drive controller 30 causes the signal charge generated by photoelectric converter 22 of each pixel 21B to be drained. Specifically, drive controller 30 outputs the exposure control pulse to each pixel 21B in the exposure periods to turn on one of charge transferers 24a, 24b, and 24c and cause the one of charge transferers 24a, 24b, and 24c to transfer signal charge from photoelectric converter 22 to a corresponding one of charge accumulators 23a, 23b, and 23c. Exposure periods P0, P1, and P2 are set to periods associated with the second emission control pulse. The relationships between the second emission control pulse and the start timings of exposure periods P0, P1, and P2 are the same as the relationships in first pulse emission and exposure period Sb1 and second pulse emission and exposure period Sb2 illustrated in FIG. 6.

First pulse emission and exposure period Sb4 includes exposure period P0, exposure period P1, exposure period P2, and a charge drain period that are repeated in the stated order until the readout period starts. The total length of exposure period P0, exposure period P1, exposure period P2, and the charge drain period is the same as cycle T2 of the second emission control pulse.

In first pulse emission and exposure period Sb4, the charge accumulator that accumulates signal charge during exposure period P0, the charge accumulator that accumulates signal charge during exposure period P1, and the charge accumulator that accumulates signal charge during exposure period P2 are mutually different. For example, during exposure period P0, charge transferer 24a is turned on and signal charge is accumulated in charge accumulator 23a. During exposure period P1, charge transferer 24b is turned on and signal charge is accumulated in charge accumulator 23b. During exposure period P2, charge transferer 24c is turned on and signal charge is accumulated in charge accumulator 23c.

During the readout period following first pulse emission and exposure period Sb4, a signal based on the signal charge accumulated during exposure period P0, a signal based on the signal charge accumulated during exposure period P1, and a signal based on the signal charge accumulated during exposure period P2 are each read out as the second pixel signal.

During first pulse emission and exposure period Sb4, drive controller 30 causes each pixel 21B to be intermittently exposed from the start of exposure of each pixel 21B until the start of readout of the second pixel signal.

In the drive sequence illustrated in FIG. 21, signal processor 40 derives the distance to the target object based on the first pixel signal and the second pixel signal. Specifically, in deriving the distance to the target object, signal processor 40 first calculates the first estimated distance and the second estimated distance. Signal processor 40 derives the distance to the target object based on the first estimated distance and the second estimated distance. Signal processor 40, for example, calculates the first estimated distance based on the first pixel signal output from each pixel 21B in the CW-ToF sequence that includes first CW emission and exposure period Sa4 described above. First estimated distance d1 in the present variation is calculated using Equation (6) below.

$$\begin{matrix}[ Math . 6 ] & \\ d 1 = \frac{c}{4 π f 1} arctan \frac{\sqrt{3} ( C 240 - C 120 )}{( C 120 - C 0 ) + ( C 240 - C 0 )} & ( 6 )\end{matrix}$$

As with Equation (1), Equation (6) shown above is an equation for calculating a distance using the phenomenon that the phase of reflected light of the irradiation light that has reflected off the target object is shifted with respect to the phase of the irradiation light according to the distance to the target object.

The second estimated distance is calculated using Equations (2) and (3) shown above.

Note that the method of deriving the distance to the target object using the first estimated distance and the second estimated distance in the drive sequence illustrated in FIG. 21 is the same as the method used in the case of the drive sequence illustrated in FIG. 4 described above.

Note that the drive sequence illustrated in FIG. 21 may include one or more other CW-ToF sequences. The distance measuring device according to Variation 1 may operate with the drive sequence illustrated in FIG. 21.

### (Others)

A distance measuring device according to one or more aspects has been described above based on an exemplary embodiment, but the present disclosure is not limited to the exemplary embodiment. Various modifications of the exemplary embodiment as well as forms resulting from combinations of constituent elements from different embodiments that may be conceived by those skilled in the art may be included within the scope of the one or more aspects so long as these do not depart from the essence of the present disclosure.

The distance measuring device according to the present disclosure need not include all the constituent elements described in the above exemplary embodiment, and may only include constituent elements necessary for performing a desired operation.

In the above embodiment, each constituent element may be implemented by executing a software program suitable for the constituent element. Each constituent element may be implemented by a program executor, such as a central processing unit (CPU) or a processor, reading and executing a software program recorded on a recording medium such as a hard disk or semiconductor memory.

Each constituent element may be implemented in the form of a hardware product. Each constituent element may be a circuit (or an integrated circuit). These circuits may be configured as a single circuit or may be individual circuits. Moreover, these circuits may be general-purpose circuits, or may be specialized circuits.

General or specific aspects of the present disclosure may be implemented as a system, a device, a method, an integrated circuit, a computer program, or a computer-readable recording medium such as a compact disc read-only memory (CD-ROM). In addition, general or specific aspects of the present disclosure may be implemented as any given combination of systems, devices, methods, integrated circuits, computer programs, or recording media.

For example, the present disclosure may be implemented as: the distance measuring device according to the above exemplary embodiment; a control device that controls a distance measuring device; a distance measuring method that includes steps (processing) performed by constituent elements included in a distance measuring device; a program for causing a computer to execute such a distance measuring method; and a non-transitory computer-readable recording medium having such a program recorded thereon.

Provided below are examples of the distance measuring device and distance measuring method according to the present disclosure described based on the above exemplary embodiment. The distance measuring device and distance measuring method according to the present disclosure are not limited to the examples below.

For example, a distance measuring device according to a first aspect of the present disclosure is a distance measuring device that measures a distance to a target object using an indirect time-of-flight (ToF) method, the distance measuring device including: a light source unit that emits irradiation light; a light receiver including a pixel that generates a pixel signal based on incident light; a drive controller that controls driving of the light source unit and the light receiver; and a signal processor that derives the distance to the target object based on the pixel signal, wherein the drive controller: drives the light source unit and the pixel through a continuous wave ToF sequence and a pulse ToF sequence that are sequences for measuring a distance using mutually different types of indirect ToF methods; and switches between the continuous wave ToF sequence and the pulse ToF sequence between frames, a distance measurement range in the pulse ToF sequence is longer than a distance measurement range in the continuous wave ToF sequence, and the signal processor derives the distance to the target object based on a first pixel signal generated by the pixel in the continuous wave ToF sequence and a second pixel signal generated by the pixel in the pulse ToF sequence.

In addition, for example, a distance measuring device according to a second aspect of the present disclosure is the distance measuring device according to the first aspect, wherein the drive controller: in the continuous wave ToF sequence, causes the pixel to be continuously exposed from a start of exposure of the pixel until a start of readout of the first pixel signal; and in the pulse ToF sequence, causes the pixel to be intermittently exposed from a start of exposure of the pixel until a start of readout of the second pixel signal.

In addition, for example, a distance measuring device according to a third aspect of the present disclosure is the distance measuring device according to the first aspect or the second aspect, wherein the light source unit emits pulsed light as the irradiation light according to an emission control pulse that is output from the drive controller, and the drive controller: in the continuous wave ToF sequence, outputs a first emission control pulse to the light source unit to cause the light source unit to emit pulsed light as the irradiation light, the first emission control pulse having a first duty cycle; and in the pulse ToF sequence, outputs a second emission control pulse to the light source unit to cause the light source unit to emit pulsed light as the irradiation light, the second emission control pulse having a second duty cycle.

In addition, for example, a distance measuring device according to a fourth aspect of the present disclosure is the distance measuring device according to the third aspect, wherein the second duty cycle is less than the first duty cycle.

In addition, for example, a distance measuring device according to a fifth aspect of the present disclosure is the distance measuring device according to the fourth aspect, wherein the second duty cycle is less than 50%.

In addition, for example, a distance measuring device according to a sixth aspect of the present disclosure is the distance measuring device according to the fifth aspect, wherein the second duty cycle is less than 25%.

In addition, for example, a distance measuring device according to a seventh aspect of the present disclosure is the distance measuring device according to any one of the third through sixth aspects, wherein a pulse width of the second emission control pulse is greater than a pulse width of the first emission control pulse.

In addition, for example, a distance measuring device according to an eighth aspect of the present disclosure is the distance measuring device according to any one of the first through seventh aspects, wherein the signal processor: calculates a first estimated distance based on the first pixel signal; calculates a second estimated distance based on the second pixel signal; and determines, as the distance to the target object, one of (i) a range-added first estimated distance or (ii) the second estimated distance, the range-added first estimated distance being calculated by n×df1+d1 using a smallest value of n among one or more values of n that result in a smallest difference between n×df1+d1 and d2, where: d1 denotes the first estimated distance; d2 denotes the second estimated distance; df1 denotes the distance measurement range in the continuous wave ToF sequence; and n denotes an integer greater than or equal to 0.

In addition, for example, a distance measuring device according to a ninth aspect of the present disclosure is the distance measuring device according to the eighth aspect, wherein the signal processor determines, as the distance to the target object, a shorter one of the second estimated distance or the range-added first estimated distance.

In addition, for example, a distance measuring device according to a tenth aspect of the present disclosure is the distance measuring device according to the eighth aspect, wherein when the second estimated distance is shorter than the range-added first estimated distance, the signal processor determines that anomalous distance measurement has been performed.

In addition, for example, a distance measuring device according to an eleventh aspect of the present disclosure is the distance measuring device according to any one of the first through tenth aspects, wherein the pixel includes: a photoelectric converter that converts the incident light into signal charge; a plurality of charge accumulators each of which accumulates the signal charge obtained by the conversion performed by the photoelectric converter; a plurality of charge transferers that transfer, to the plurality of charge accumulators, the signal charge obtained by the conversion performed by the photoelectric converter, the plurality of charge transferers corresponding one-on-one to the plurality of charge accumulators; a charge drainer that drains the signal charge obtained by the conversion performed by the photoelectric converter; and a drain controller that controls draining of the signal charge performed by the charge drainer.

In addition, for example, a distance measuring device according to a twelfth aspect of the present disclosure is the distance measuring device according to any one of the first through eleventh aspects, wherein the continuous wave ToF sequence includes a first continuous wave ToF frame and a second continuous wave ToF frame that are mutually different in timing at which the pixel is exposed with respect to a timing at which the light source unit emits the irradiation light, the pulse ToF sequence includes a first pulse ToF frame and a second pulse ToF frame that are mutually different in timing at which the pixel is exposed with respect to a timing at which the light source unit emits the irradiation light, and the drive controller repeats, for a predetermined number of times, a set including the first continuous wave ToF frame, the second continuous wave ToF frame, the first pulse ToF frame, and the second pulse ToF frame, the set being a unit of repetition.

In addition, for example, a distance measuring device according to a thirteenth aspect of the present disclosure is the distance measuring device according to any one of the first through eleventh aspects, wherein the continuous wave ToF sequence includes a first continuous wave ToF frame and a second continuous wave ToF frame that are mutually different in timing at which the pixel is exposed with respect to a timing at which the light source unit emits the irradiation light, the pulse ToF sequence includes a first pulse ToF frame in which the pixel is exposed at a predetermined timing with respect to the timing at which the light source unit emits the irradiation light, and the drive controller repeats, for a predetermined number of times, a set including the first continuous wave ToF frame, the second continuous wave ToF frame, and the first pulse ToF frame, the set being a unit of repetition.

In addition, for example, a distance measuring device according to a fourteenth aspect of the present disclosure is the distance measuring device according to any one of the first through eleventh aspects, wherein the continuous wave ToF sequence includes a first continuous wave ToF frame in which the pixel is exposed at a predetermined timing with respect to a timing at which the light source unit emits the irradiation light, the pulse ToF sequence includes a first pulse ToF frame in which the pixel is exposed at a predetermined timing with respect to the timing at which the light source unit emits the irradiation light, and the drive controller repeats, for a predetermined number of times, a set including the first continuous wave ToF frame and the first pulse ToF frame, the set being a unit of repetition.

In addition, for example, a distance measuring device according to a fifteenth aspect of the present disclosure is the distance measuring device according to any one of the first through fourteenth aspects, wherein the drive controller drives the light source unit and the pixel through the continuous wave ToF sequence, the pulse ToF sequence, and an other continuous wave ToF sequence that is longer than the continuous wave ToF sequence in distance measurement range, and the signal processor derives the distance to the target object based on the first pixel signal, the second pixel signal, and a third pixel signal generated by the pixel in the other continuous wave ToF sequence.

In addition, for example, a distance measuring device according to a sixteenth aspect of the present disclosure is distance measuring method performed by a distance measuring device for measuring a distance to a target object using an indirect time-of-flight (ToF) method, the distance measuring device including: a light source unit that emits irradiation light; and a light receiver including a pixel that generates a pixel signal based on incident light, the distance measuring method including: driving the light source unit and the pixel through a continuous wave ToF sequence and a pulse ToF sequence that are sequences for measuring a distance using mutually different types of indirect ToF methods; and deriving the distance to the target object based on a first pixel signal generated by the pixel in the continuous wave ToF sequence and a second pixel signal generated by the pixel in the pulse ToF sequence, wherein the driving includes switching between the continuous wave ToF sequence and the pulse ToF sequence between frames, and a distance measurement range in the pulse ToF sequence is longer than a distance measurement range in the continuous wave ToF sequence.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The distance measuring device and the like according to the present disclosure are applicable to various applications such as a sensing system and a recognition system that use a distance image, and a distance measurement system.

1. A distance measuring device that measures a distance to a target object using an indirect time-of-flight (ToF) method, the distance measuring device comprising:
a light source unit that emits irradiation light;
a light receiver including a pixel that generates a pixel signal based on incident light;
a drive controller that controls driving of the light source unit and the light receiver; and
a signal processor that derives the distance to the target object based on the pixel signal, wherein
the drive controller:
drives the light source unit and the pixel through a continuous wave ToF sequence and a pulse ToF sequence that are sequences for measuring a distance using mutually different types of indirect ToF methods; and
switches between the continuous wave ToF sequence and the pulse ToF sequence between frames,
a distance measurement range in the pulse ToF sequence is longer than a distance measurement range in the continuous wave ToF sequence, and
the signal processor derives the distance to the target object based on a first pixel signal generated by the pixel in the continuous wave ToF sequence and a second pixel signal generated by the pixel in the pulse ToF sequence.

2. The distance measuring device according to claim 1, wherein
the drive controller:
in the continuous wave ToF sequence, causes the pixel to be continuously exposed from a start of exposure of the pixel until a start of readout of the first pixel signal; and
in the pulse ToF sequence, causes the pixel to be intermittently exposed from a start of exposure of the pixel until a start of readout of the second pixel signal.

3. The distance measuring device according to claim 1, wherein
the light source unit emits pulsed light as the irradiation light according to an emission control pulse that is output from the drive controller, and
the drive controller:
in the continuous wave ToF sequence, outputs a first emission control pulse to the light source unit to cause the light source unit to emit pulsed light as the irradiation light, the first emission control pulse having a first duty cycle; and
in the pulse ToF sequence, outputs a second emission control pulse to the light source unit to cause the light source unit to emit pulsed light as the irradiation light, the second emission control pulse having a second duty cycle.

4. The distance measuring device according to claim 3, wherein the second duty cycle is less than the first duty cycle.

5. The distance measuring device according to claim 4, wherein the second duty cycle is less than 50%.

6. The distance measuring device according to claim 5, wherein the second duty cycle is less than 25%.

7. The distance measuring device according to claim 3, wherein
a pulse width of the second emission control pulse is greater than a pulse width of the first emission control pulse.

8. The distance measuring device according to claim 1, wherein
the signal processor:
calculates a first estimated distance based on the first pixel signal;
calculates a second estimated distance based on the second pixel signal; and
determines, as the distance to the target object, one of (i) a range-added first estimated distance or (ii) the second estimated distance, the range-added first estimated distance being calculated by n×df1 +d1 using a smallest value of n among one or more values of n that result in a smallest difference between n×df1+d1 and d2, where: d1 denotes the first estimated distance; d2 denotes the second estimated distance; df1 denotes the distance measurement range in the continuous wave ToF sequence; and n denotes an integer greater than or equal to 0.

9. The distance measuring device according to claim 8, wherein
the signal processor determines, as the distance to the target object, a shorter one of the second estimated distance or the range-added first estimated distance.

10. The distance measuring device according to claim 8, wherein
when the second estimated distance is shorter than the range-added first estimated distance, the signal processor determines that anomalous distance measurement has been performed.

11. The distance measuring device according to claim 1, wherein
the pixel includes:
a photoelectric converter that converts the incident light into signal charge;
a plurality of charge accumulators each of which accumulates the signal charge obtained by the conversion performed by the photoelectric converter;
a plurality of charge transferers that transfer, to the plurality of charge accumulators, the signal charge obtained by the conversion performed by the photoelectric converter, the plurality of charge transferers corresponding one-on-one to the plurality of charge accumulators;
a charge drainer that drains the signal charge obtained by the conversion performed by the photoelectric converter; and
a drain controller that controls draining of the signal charge performed by the charge drainer.

12. The distance measuring device according to claim 1, wherein
the continuous wave ToF sequence includes a first continuous wave ToF frame and a second continuous wave ToF frame that are mutually different in timing at which the pixel is exposed with respect to a timing at which the light source unit emits the irradiation light,
the pulse ToF sequence includes a first pulse ToF frame and a second pulse ToF frame that are mutually different in timing at which the pixel is exposed with respect to a timing at which the light source unit emits the irradiation light, and
the drive controller repeats, for a predetermined number of times, a set including the first continuous wave ToF frame, the second continuous wave ToF frame, the first pulse ToF frame, and the second pulse ToF frame, the set being a unit of repetition.

13. The distance measuring device according to claim 1, wherein
the continuous wave ToF sequence includes a first continuous wave ToF frame and a second continuous wave ToF frame that are mutually different in timing at which the pixel is exposed with respect to a timing at which the light source unit emits the irradiation light,
the pulse ToF sequence includes a first pulse ToF frame in which the pixel is exposed at a predetermined timing with respect to the timing at which the light source unit emits the irradiation light, and
the drive controller repeats, for a predetermined number of times, a set including the first continuous wave ToF frame, the second continuous wave ToF frame, and the first pulse ToF frame, the set being a unit of repetition.

14. The distance measuring device according to claim 1, wherein
the continuous wave ToF sequence includes a first continuous wave ToF frame in which the pixel is exposed at a predetermined timing with respect to a timing at which the light source unit emits the irradiation light,
the pulse ToF sequence includes a first pulse ToF frame in which the pixel is exposed at a predetermined timing with respect to the timing at which the light source unit emits the irradiation light, and
the drive controller repeats, for a predetermined number of times, a set including the first continuous wave ToF frame and the first pulse ToF frame, the set being a unit of repetition.

15. The distance measuring device according to claim 1, wherein
the drive controller drives the light source unit and the pixel through the continuous wave ToF sequence, the pulse ToF sequence, and an other continuous wave ToF sequence that is longer than the continuous wave ToF sequence in distance measurement range, and
the signal processor derives the distance to the target object based on the first pixel signal, the second pixel signal, and a third pixel signal generated by the pixel in the other continuous wave ToF sequence.

16. A distance measuring method performed by a distance measuring device for measuring a distance to a target object using an indirect time-of-flight (ToF) method,
the distance measuring device including:
a light source unit that emits irradiation light; and
a light receiver including a pixel that generates a pixel signal based on incident light,
the distance measuring method comprising:
driving the light source unit and the pixel through a continuous wave ToF sequence and a pulse ToF sequence that are sequences for measuring a distance using mutually different types of indirect ToF methods; and
deriving the distance to the target object based on a first pixel signal generated by the pixel in the continuous wave ToF sequence and a second pixel signal generated by the pixel in the pulse ToF sequence, wherein
the driving includes switching between the continuous wave ToF sequence and the pulse ToF sequence between frames, and
a distance measurement range in the pulse ToF sequence is longer than a distance measurement range in the continuous wave ToF sequence.
